(19) United States
(12) Patent Application Publication
(10) Pub. No.: US 2009/0174970 A1
(43) Pub. Date: Jul. 9, 2009

(54) MAGNETIC RECORDING MEDIUM, MAGNETIC SIGNAL REPRODUCTION SYSTEM AND MAGNETIC SIGNAL REPRODUCTION METHOD

(76) Inventors: Kenichiro Inoue, Kanagawa (JP); Takeshi Harasawa, Kanagawa (JP); Satoshi Matsubaguchi, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 12/295,510

(22) PCT Filed: Mar. 30, 2007
(86) PCT No.: PCT/JP2007/057298

§ 371 Date: Sep. 30, 2008

(30) Foreign Application Priority Data
Mar. 30, 2006 (JP) 2006-094971

(51) Int. Cl. G11B 5/33; G11B 5/127; G11B 5/66

(52) U.S. Cl. 360/324; 360/313; 428/831; G9B/5.104; G9B/5.04

(57) ABSTRACT

The present invention relates to a magnetic recording medium comprising a nonmagnetic layer comprising a nonmagnetic powder and a binder and a magnetic layer comprising a ferromagnetic powder and a binder in this order on a nonmagnetic support. The magnetic layer has a thickness ranging from 30 to 130 nm, and a glossiness of the magnetic layer surface ranges from 155 to 270 percent.

### CROSS-REFERENCE TO RELATED APPLICATIONS

This application claims the benefit of priority to Japanese Patent Application No. 2006-094971 filed on Mar. 30, 2006, which is expressly incorporated herein by reference in its entirety.

### TECHNICAL FIELD

The present invention relates to a magnetic recording medium, and more particularly, to a magnetic recording medium having excellent electromagnetic characteristics in high-density recording that is particularly suited to reproduction with giant magnetoresistive magnetic heads (GMR heads). The present invention further relates to a magnetic signal reproduction system and a magnetic signal reproduction method employing the above magnetic recording medium.

### BACKGROUND TECHNIQUE

In recent years, means for rapidly transmitting information have undergone marked development. It has become possible to transmit data and images comprising huge amounts of information. With this improvement in data transmission technology has come demand for recording and reproduction devices and recording media for recording, reproducing, and storing information with greater recording capacity.

To achieve greater recording capacity, high recording density techniques such as the use of magnetic powder in the form of microparticles, the high density filling of coatings with such microparticles, the smoothing of coatings, and reduction of the thickness of the magnetic layer have been proposed as approaches from the aspect of magnetic tape manufacturing. For example, Japanese Unexamined Patent Publication (KOKAI) Heisei No. 8-306032 (“Reference 1” hereinafter, which is expressly incorporated herein by reference in its entirety) proposes the incorporation of a phosphorus-containing organic compound into the lower layer to enhance dispersion of inorganic powder in the lower layer and ensure the surface properties of the magnetic layer. Further, Japanese Unexamined Patent Publication (KOKAI) Heisei Nos. 6-325345 (“Reference 2” hereinafter, which is expressly incorporated herein by reference in its entirety) and 10-320756 (“Reference 3” hereinafter, which is expressly incorporated herein by reference in its entirety) propose specifying the surface glossiness of the magnetic layer to within a prescribed range.

Additionally, the wavelength of the recording signal is being shortened and the width of the recording track is being narrowed as approaches from the aspect of the recording and reproduction device. Narrowing of the track width of the reproduction head is also being pursued so that the reproduction head can follow the narrowed recording track. Since pursuing such narrowing of the track width deteriorates the S/N ratio, reproduction is required to be conducted with a highly sensitive head. Thus, reproducing the signal with a highly sensitive magnetoresistive head (MR head) has been proposed and put into practice. In recent years, giant magnetoresistive heads (GMR heads) utilizing the giant magnetoresistive effect have been proposed as more highly sensitive reproduction heads, and have actually been used in the area of hard disks.

However, the present inventors discovered through investigation that noise increased and an adequate S/N ratio could not be achieved with the techniques described in References 1 to 3 in the short wavelength recording region with a magnetic recording medium of multilayered configuration in which the thickness of the magnetic layer had been reduced to achieve higher density recording, particularly in a recording and reproduction system employing a GMR head as the reproduction head.

### DISCLOSURE OF THE INVENTION

Accordingly, it is an object of the present invention to provide a magnetic recording medium of multilayered configuration having a thin magnetic layer and affording a good S/N ratio in the short wavelength region, particularly a magnetic recording medium affording a good S/N ratio during reproduction particularly with a GMR head.

The present inventors conducted extensive research into achieving the above-stated object, resulting in the following discovery.

As described in Reference 3, a magnetic recording medium having a magnetic layer of relatively thick monolayer structure presented thickness loss problems in the form of a self-demagnetization in the recording process and a drop in output in the reproduction process.

By contrast, References 1 and 2 disclose magnetic recording media of multilayered structures in which a magnetic layer that is thinner than the magnetic layer described in Reference 3 is formed on a nonmagnetic layer. This permits a certain degree of improvement in the output drop due to the above-described thickness loss of the magnetic layer. However, investigation by the present inventors revealed that since the magnetic layer formed over the nonmagnetic layer was relatively thick in the magnetic recording media in Examples of References 1 and 2, for example, it was difficult to achieve an adequate S/N ratio in the short wavelength recording region when the surface glossiness of the magnetic layer was specified to the range stated in Reference 2. In particular, it was extremely difficult to achieve a good S/N ratio during reproduction with an MR head (particularly a GMR head). This was attributed to the fact that, due to the magnetic layer still being relatively thick, the recording and reproduction characteristics deteriorated in the short wavelength region, and the saturation magnetic flux φm per unit area of the magnetic layer increased, resulting in saturation of the MR head.

The present inventors continued their research based on the above discoveries.

Glossiness is an indication of the reflectance of visible light, indicating roughness in the relatively short wavelength. Accordingly, it is important to enhance glossiness to enhance short wavelength characteristics. Conventionally, glossiness has been understood as being indicative of the surface properties, fill property, and arrangement of the magnetic layer. Thus, Reference 2 proposes that the surface glossiness be controlled based on the surface properties, fill property, and arrangement of the magnetic layer. However, research conducted by the present inventors revealed that when the thickness of the magnetic layer was greatly reduced (to equal to or less than 130 nm), not only did the magnetic layer affect surface glossiness, but the surface properties of the layer beneath the magnetic layer—that is, the interface between the magnetic layer and the nonmagnetic layer—also had an effect. This was attributed to the major effect of the roughness of the interface (interface variation) between the nonmagnetic layer and the magnetic layer on surface glossiness due to the passage of light when the thickness of the magnetic layer was greatly reduced.

The present inventors pursued their investigation based on the above discoveries, discovering that by controlling the roughness of the interface between the magnetic layer and the nonmagnetic layer to achieve a glossiness of 155 to 270 percent in addition to controlling the surface properties, fill property, and arrangement of the magnetic layer, it was possible to achieve excellent characteristics in the short wavelength region and obtain a good S/N ratio during MR head reproduction, particularly during GMR head reproduction. The present invention was devised on that basis.

That is, the above-stated object was achieved by the following means:

[1] A magnetic recording medium comprising a nonmagnetic layer comprising a nonmagnetic powder and a binder and a magnetic layer comprising a ferromagnetic powder and a binder in this order on a nonmagnetic support, wherein

the magnetic layer has a thickness ranging from 30 to 130 nm, and

a glossiness of the magnetic layer surface ranges from 155 to 270 percent.

[2] The magnetic recording medium according to [1], wherein a saturation magnetic flux φm per unit area of the magnetic layer is equal to or greater than 5 mT·μm and equal to or less than 20 mT·μm.
[3] The magnetic recording medium according to [2], wherein the glossiness of the magnetic layer surface is equal to or greater than (5×φm+130) percent and equal to or less than 270 percent.
[4] The magnetic recording medium according to any of [1] to [3], wherein the ferromagnetic powder is a hexagonal ferrite powder.
[5] The magnetic recording medium according to [4], wherein the hexagonal ferrite powder has an average plate diameter ranging from 10 to 40 nm and an average plate ratio ranging from 1.5 to 4.5.
[6] The magnetic recording medium according to any of [1] to [5], which is employed in a magnetic signal reproduction system employing a giant magnetoresistive magnetic head as a reproduction head.
[7] A magnetic signal reproduction system, comprising:

the magnetic recording medium according to any of [1] to [5], and

a reproduction head.

[8] The magnetic signal reproduction system according to [7], wherein

the reproduction head is a giant magnetoresistive magnetic head.

[9] A magnetic signal reproduction method, reproducing magnetic signals that have been recorded on the magnetic recording medium according to any of [1] to [5] with a reproduction head.
[10] The magnetic signal reproduction method according to [9], wherein

the reproduction head is a giant magnetoresistive magnetic head.

The present invention can provide a magnetic recording medium exhibiting excellent electromagnetic characteristics over a broad range of wavelengths, exhibiting good electromagnetic characteristics specifically in the short wavelength region, that is particularly suited to reproduction with GMR heads.

### BEST MODE FOR CARRYING OUT THE INVENTION

### Magnetic Recording Medium

The magnetic recording medium of the present invention is a magnetic recording medium comprising a nonmagnetic layer comprising a nonmagnetic powder and a binder and a magnetic layer comprising a ferromagnetic powder and a binder in this order on a nonmagnetic support. In the magnetic recording medium of the present invention, the magnetic layer has a thickness ranging from 30 to 130 nm, and a glossiness of the magnetic layer surface ranges from 155 to 270 percent.

The magnetic recording medium of the present invention will be described below.

In the magnetic recording medium of the present invention, the thickness of the magnetic layer ranges from 30 to 130 nm. When the thickness of the magnetic layer falls within the above range, magnetic signals can be recorded at high density. Conversely, when the thickness of the magnetic layer exceeds 130 nm, the head tends to become saturated when an MR head is employed, making it difficult to achieve good electromagnetic characteristics. When the magnetic layer is less than 30 nm in thickness, it becomes difficult to apply the magnetic layer in a uniform coating. Within the above-stated range, it is desirable to optimize the thickness of the magnetic layer based on the saturation magnetization level and the head gap length of the magnetic head employed and the frequency band of the recording signal. The thickness of the magnetic layer desirably ranges from 30 to 120 nm, preferably ranges from 30 to 100 nm, and more preferably, ranges from 30 to 80 nm.

As the magnetic layer becomes thicker as set forth above, the MR head tends to saturate. This is because in general, the thicker the magnetic layer, the larger the saturation magnetic flux φm per unit area becomes. From the perspective of preventing saturation of the MR head, the saturation magnetic flux φm per unit area of the magnetic layer is desirably equal to or less than 20 mT·μm. From the perspective of ensuring reproduction output, φm is desirably equal to or greater than 5 mT·μm. φm is preferably 10 to 18 mT·μm, and more preferably within a range of 12 to 18 mT·μm.

φm is calculated as Bmδ by multiplying the maximum magnetic flux density Bm of the magnetic layer with the thickness δ of the magnetic layer, and can be directly measured with a vibrating sample fluxmeter. Specifically, it can be measured at Hm 790 kA/m (10,000 Oe) using a vibrating sample fluxmeter made by Toei Industrial Co. It suffices to determine the maximum magnetic flux density Bm of the magnetic layer by taking into account above-mentioned φm; for example, it can be set to within a range of, for example, 100 to 200 mT, desirably within a range of 120 to 180 mT, and preferably, to within a range of 140 to 180 mT. The maximum magnetic flux density of the magnetic layer can be controlled by means of the magnetic characteristics of the ferromagnetic powder and the fill rate of the magnetic layer.

In the present invention, the glossiness of the surface of the magnetic layer ranges from 155 to 270 percent in a magnetic recording medium of multilayered structure having a magnetic layer 30 to 130 nm in thickness. As set forth above, the present inventors discovered through research that the recording characteristics in the short wavelength region deteriorated markedly when the glossiness of the surface of the magnetic layer was less than 155 percent in a magnetic recording medium having a thin magnetic layer 30 to 130 nm in thickness. This was attributed to the effect of the roughness of the interface between the nonmagnetic layer and the magnetic layer on the glossiness of the magnetic layer surface in a magnetic recording medium having a thin magnetic layer as set forth above. On the other hand, the higher the glossiness, the higher the reproduction output, but excessively high glossiness reduced the strength of the coating and thus compromised durability. Accordingly, to achieve both durability and good short wavelength recording characteristics in the present invention, the glossiness of the surface of the magnetic layer is set to within a range of 155 to 270 percent. Further, the glossiness of the surface of the magnetic layer is desirably set to within a range of equal to or higher than (5×φm+130) and equal to or less than 270 percent, preferably to within a range of (5×φm+140) percent to 270 percent, and more preferably, to within a range of (5×φm+150) percent to 270 percent.

In the present invention, the term “glossiness” of the surface of the magnetic layer means a value that is measured with a gloss meter according to JIS Z8741 with the mirror-surface glossiness of a glass surface with a refractive index of 1.567 at an angle of incidence of 45° as 100 percent.

A method of achieving a magnetic layer with a surface glossiness of 155 to 270 percent will be described below.

As set forth above, in a magnetic recording medium of multilayered structure having a thin magnetic layer 30 to 130 nm in thickness, the glossiness of the surface of the magnetic layer is affected by: (i) the smoothness of the surface of the magnetic layer, (ii) the orientation of the magnetic layer, (iii) the fill property of the magnetic layer, and (iv) the roughness (interface variation) of the interface of the magnetic layer and the nonmagnetic layer. Thus, the glossiness of the surface of the magnetic layer can be kept to within the desired range by controlling (i) to (iv) above. Generally, in a wet-on-wet coating method in which the magnetic layer is coated while the nonmagnetic layer is still wet, there tends to be considerable variation in the interface between the magnetic layer and the nonmagnetic layer. Thus, to reduce the roughness of the interface between the magnetic layer and the nonmagnetic layer, the magnetic layer and nonmagnetic layer are desirably coated by a wet-on-dry coating method in which the magnetic layer is coated after the nonmagnetic layer has been coated and dried on the nonmagnetic support.

The smoothness of the surface of the nonmagnetic layer is desirably increased prior to coating the magnetic layer to reduce the roughness of the interface between the magnetic layer and the nonmagnetic layer. Examples of means of achieving this are: (a) employing a support with good smoothness, (b) using a nonmagnetic powder of microparticles, (c) highly dispersing the nonmagnetic layer (through the selection of the binder, steps, and disperser), (d) processing the nonmagnetic layer to render it smooth (smoothing, calendering), and (e) forming a smooth layer. Smoothing is a process in which a shear is applied in the coating direction while the coating layer is still wet immediately after coating the nonmagnetic layer on the nonmagnetic support, and is effective in breaking up aggregate in the coating layer. Normally, a hard platelike smoother (desirably having a center surface average surface roughness Ra≦2.5 nm) is brought into contact with the surface while wet to apply a shear. In calendering, the calender roll temperature, pressure, speed, material, surface properties, roll configuration, and the like are suitably set.

By improving the resistance to solvent of the surface of the nonmagnetic layer prior to coating the magnetic layer, it is possible to prevent the nonmagnetic layer from dissolving into the magnetic layer coating liquid and causing the interface between the magnetic layer and nonmagnetic layer to roughen. Specifically, the resistance to solvent of the surface of the nonmagnetic layer can be improved by the method of employing a thermosetting resin in the nonmagnetic layer and conducting thermoprocessing and/or the method of employing a radiation-curable compound in the nonmagnetic layer and conducting radiation processing prior to coating the magnetic layer.

The details of the various means set forth above will be individually described further below. The glossiness of the surface of the magnetic layer can be kept to within a range of 155 to 270 percent in a magnetic recording medium of multilayered structure having a magnetic layer 30 to 130 nm in thickness by optionally combining any of the above-mentioned means in the present invention.

The magnetic recording medium of the present invention will be described in greater detail below.

Nonmagnetic Support

A known film in the form of a polyester such as polyethylene terephthalate or polyethylene naphthalate, polyolefins, cellulose triacetate, polycarbonate, polyamide, polyimide, polyamidoimide, polysulfone, polyaramide, aromatic polyamide, or polybenzooxazole can be employed as the nonmagnetic support. The use of a high-strength support such as polyethylene naphthalate or polyamide is desirable. As needed, laminated supports such as those disclosed in Japanese Unexamined Patent Publication (KOKAI) Heisei No. 3-224127 can be employed to vary the surface roughness of the magnetic surface and the nonmagnetic support surface. The content of the above publication is expressly incorporated herein by reference in its entirety. These supports can be corona discharge treated, plasma treated, treated to facilitate adhesion, heat treated, treated to remove dust, or the like in advance. An aluminum or glass substrate can also be employed as the support.

Of these, a polyester support (referred to simply as “polyester” hereinafter) is desirable. The polyester is desirably comprised of dicarboxylic acid and a diol, such as polyethylene terephthalate and polyethylene naphthalate.

Examples of the dicarboxylic acid component serving as the main structural component are: terephthalic acid, isophthalic acid, phthalic acid, 2,6-naphthalene dicarboxylic acid, 2,7-naphthalene dicarboxylic acid, diphenylsulfone dicarboxylic acid, diphenylether dicarboxylic acid, diphenylethane dicarboxylic acid, cyclohexane dicarboxylic acid, diphenyl dicarboxylic acid, diphenylthioether dicarboxylic acid, diphenylketone dicarboxylic acid, and phenylindane dicarboxylic acid.

Examples of the diol component are: ethylene glycol, propylene glycol, tetramethylene glycol, cyclohexane dimethanol, 2,2-bis(4-hydroxyphenyl)propane, 2,2-bis(4-hydroxyethoxyphenyl)propane, bis(4-hydroxyphenyl)sulfone, bisphenolfluorene dihydroxyethyl ether, diethylene glycol, neopentyl glycol, hydroquinone, and cyclohexanediol.

Among polyesters employing these compounds as main structural components, those comprising main structural components in the form of a dicarboxylic acid component in the form of terephthalic acid and/or 2,6-naphthalene dicarboxylic acid, and a diol component in the form of ethylene glycol and/or 1,4-cyclohexane dimethanol, are desirable from the perspectives of transparency, mechanical strength, dimensional stability, and the like.

Among these, polyesters comprising main structural components in the form of polyethylene terephthalate or polethylene-2,6-naphthalate; copolymer polyesters comprised of terephthalic acid, 2,6-naphthalene dicarboxylic acid, and ethylene glycol; and polyesters comprising main structural components in the form of mixtures of two or more of these polyesters are preferred. Polyesters comprising polyethylene-2,6-naphthalate as the main structural component are of even greater preference.

The polyester may be biaxially oriented, and may be a laminate with two or more layers.

Other copolymer components may be copolymerized and other polyesters may be mixed into the polyester. Examples are the dicarboxylic acid components and diol components given above by way of example, and polyesters comprised of them.

To help prevent delamination when used in films, aromatic dicarboxylic acids having sulfonate groups or ester-forming derivatives thereof, dicarboxylic acids having polyoxyalkylene groups or ester-forming derivatives thereof, diols having polyoxyalkylene groups, or the like can be copolymerized in the polyester.

Among these, 5-sodiumsulfoisophthalic acid, 2-sodiumsulfoterephthalic acid, 4-sodiumsulfophthalic acid, 4-sodiumsulfo-2,6-naphthylene dicarboxylic acid, compounds in which the sodium in these compounds has been replaced with another metal (such as potassium or lithium), ammonium salt, phosphonium salt, or the like, ester-forming compounds thereof, polyethylene glycol, polytetramethylene glycol, polyethylene glycol-polypropylene glycol copolymers, compounds in which the two terminal hydroxy groups of these compounds have been oxidized or the like to form carboxyl groups, and the like are desirable from the perspectives of the polyester polymerization reaction and film transparency. The ratio of copolymerization to achieve this end is desirably 0.1 to 10 mol percent based on the dicarboxylic acid constituting the polyester.

Further, to increase heat resistance, a bisphenol compound or a compound having a naphthalene ring or cyclohexane ring can be copolymerized. The copolymerization ratio of these compounds is desirably 1 to 20 mol percent based on the dicarboxylic acid constituting the polyester.

The above polyesters can be manufactured according to conventional known polyester manufacturing methods. An example is the direct esterification method, in which the dicarboxylic acid component is directly esterification reacted with the diol component. It is also possible to employ a transesterification method in which a dialkyl ester is first employed as a dicarboxylic acid component to conduct a transesterification reaction with a diol component, and the product is then heated under reduced pressure to remove the excess diol component and conduct polymerization. In this process, transesterification catalysts and polymerization catalysts may be employed and heat-resistant stabilizers added as needed.

One or more of various additives such as anticoloring agents, oxidation inhibitors, crystal nucleus agents, slipping agents, stabilizers, antiblocking agents, UV absorbents, viscosity-regulating agents, defoaming transparency-promoting agents, antistatic agents, pH-regulating agents, dyes, pigments, and reaction-stopping agents can be added at any step during synthesis.

Filler can be added to the polyester. Examples of fillers are: inorganic powders such as spherical silica, colloidal silica, titanium oxide, and alumina, and organic fillers such as crosslinked polystyrene and silicone resin.

Further, to render the supports highly rigid, these materials can be highly oriented, and surface layers of metals, semimetals, and oxides thereof can be provided.

In the present invention, the nonmagnetic support is desirably 3 to 80 micrometers, preferably 3 to 50 micrometers, and more preferably, 3 to 10 micrometers in thickness. To set the glossiness of the magnetic layer surface within the desired range as set forth above, the nonmagnetic support with high smoothness is preferably employed. The center surface average roughness (Ra) of the support surface is desirably equal to or less than 6 nm, preferably equal to or less than 4 nm, more preferably 0.8 nm to 4 nm. Ra is a value that is measured with an HD2000 made by WYKO.

Further, the Young's modulus of the nonmagnetic support is desirably equal to or greater than 6.0 GPa, preferably equal to or greater than 7.0 GPa, in the longitudinal and width directions.

The magnetic recording medium of the present invention has a magnetic layer comprising a ferromagnetic powder and a binder on at least one surface of the above nonmagnetic support, and has a nonmagnetic layer (also referred to as the lower layer and nonmagnetic lower layer) that is essentially nonmagnetic between the nonmagnetic support and the magnetic layer.

Magnetic Layer

Examples of the ferromagnetic powder contained in the magnetic layer are ferromagnetic metal powder, hexagonal ferrite powder, and iron nitride powder.

(i) Hexagonal Ferrite Powder

Examples of hexagonal ferrite powders are barium ferrite, strontium ferrite, lead ferrite, calcium ferrite, and various substitution products thereof such as Co substitution products. Specific examples are magnetoplumbite-type barium ferrite and strontium ferrite; magnetoplumbite-type ferrite in which the particle surfaces are covered with spinels; and magnetoplumbite-type barium ferrite, strontium ferrite, and the like partly comprising a spinel phase. The following may be incorporated into the hexagonal ferrite powder in addition to the prescribed atoms: Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb and the like. Compounds to which elements such as Co—Zn, Co—Ti, Co—Ti—Zr, Co—Ti—Zn, Ni—Ti—Zn, Nb—Zn—Co, Sb—Zn—Co, and Nb—Zn have been added may generally also be employed. They may comprise specific impurities depending on the starting materials and manufacturing methods employed.

When the length of the signal recording region approaches the size of the magnetic material contained in the magnetic layer, it becomes impossible to create a distinct magnetization transition state, essentially precluding recording. Thus, the shorter the recording wavelength becomes, the smaller the magnetic material should be. In the present invention, to achieve good recording in the short-wavelength region, the use of hexagonal ferrite powder having an average plate diameter falling within a range of 10 to 40 nm is preferable, a range of 15 to 30 nm is more preferable, and a range of 20 to 25 nm is of still greater preference.

An average plate ratio [arithmetic average of (plate diameter/plate thickness)] of the hexagonal ferrite preferably ranges from 1 to 15, more preferably 1 to 7. When the average plate diameter ranges from 1 to 15, adequate orientation can be achieved while maintaining high filling property in the magnetic layer, as well as increased noise due to stacking between particles can be suppressed. The specific surface area by BET method (S_{BET}) within the above particle size range is preferably equal to or higher than 40 m²/g, more preferably 40 to 200 m²/g, and particularly preferably, 60 to 100 m²/g.

Narrow distributions of particle plate diameter and plate thickness of the hexagonal ferrite powder are normally good. About 500 particles can be randomly measured in a transmission electron microscope (TEM) photograph of particles to measure the particle plate diameter and plate thickness. The distributions of particle plate diameter and plate thickness are often not a normal distribution. However, when expressed as the standard deviation to the average size, σ/average size is 0.1 to 1.0. In general, the particle producing reaction system is rendered as uniform as possible and the particles produced are subjected to a distribution-enhancing treatment to achieve a narrow particle size distribution. For example, methods such as selectively dissolving ultrafine particles in an acid solution by dissolution are known.

A coercivity (Hc) of the hexagonal ferrite powder of about 143.3 to 318.5 kA/m (1800 to 4,000 Oe) can normally be achieved. The coercivity (Hc) of the hexagonal ferrite powder preferably ranges from 159.2 to 238.9 kA/m (2,000 to 3,000 Oe), more preferably 191.0 to 214.9 kA/m (2,200 to 2,800 Oe).

The coercivity (Hc) can be controlled by particle size (plate diameter and plate thickness), the types and quantities of elements contained, substitution sites of the element, the particle producing reaction conditions, and the like.

The φm of the magnetic layer can also be controlled by means of the saturation magnetization (σs) of the hexagonal ferrite powder. The higher saturation magnetization (σₛ) is normally preferred, however, it tends to decrease with decreasing particle size. In the present invention, the saturation magnetization (σₛ) of the hexagonal ferrite powder is desirably selected based on the desired φm, and specifically preferably within a range of 30 to 80 A·m²/kg (30 to 80 emu/g). Known methods of improving saturation magnetization (as) are combining spinel ferrite with magnetoplumbite ferrite, selection of the type and quantity of elements incorporated, and the like. It is also possible to employ W-type hexagonal ferrite. When dispersing the magnetic material, the particle surface of the magnetic material can be processed with a substance suited to a dispersion medium and a polymer. Both organic and inorganic compounds can be employed as surface treatment agents. Examples of the principal compounds are oxides and hydroxides of Si, Al, P, and the like; various silane coupling agents; and various titanium coupling agents. The quantity of surface treatment agent added normally range from 0.1 to 10 mass percent relative to the mass of the magnetic material. The pH of the magnetic material is also important to dispersion. A pH of about 4 to 12 is usually optimum for the dispersion medium and polymer. From the perspective of the chemical stability and storage properties of the medium, a pH of about 6 to 11 is normally selected. Moisture contained in the magnetic material also affects dispersion. There is an optimum level for the dispersion medium and polymer, usually selected from the range of 0.01 to 2.0 percent.

Methods of manufacturing the hexagonal ferrite powder include: (1) a vitrified crystallization method consisting of mixing into a desired ferrite composition barium oxide, iron oxide, and a metal oxide substituting for iron with a glass forming substance such as boron oxide; melting the mixture; rapidly cooling the mixture to obtain an amorphous material; reheating the amorphous material; and refining and comminuting the product to obtain a barium ferrite crystal powder; (2) a hydrothermal reaction method consisting of neutralizing a barium ferrite composition metal salt solution with an alkali; removing the by-product; heating the liquid phase to equal to or greater than 100° C.; and washing, drying, and comminuting the product to obtain barium ferrite crystal powder; and (3) a coprecipitation method consisting of neutralizing a barium ferrite composition metal salt solution with an alkali; removing the by-product; drying the product and processing it at equal to or less than 1,100° C.; and comminuting the product to obtain barium ferrite crystal powder. Any manufacturing method can be selected in the present invention. As needed, the hexagonal ferrite powder can be surface treated with Al, Si, P, or an oxide thereof. The quantity can be set to 0.1 to 10 mass percent of the ferromagnetic powder. When applying a surface treatment, the quantity of a lubricant such as a fatty acid that is adsorbed is desirably not greater than 100 mg/m². The hexagonal ferrite powder will sometimes contain inorganic ions such as soluble Na, Ca, Fe, Ni, or Sr. These are desirably substantially not present, but seldom affect characteristics at equal to or less than 200 ppm.

(ii) Iron Nitride Powder

(ii) Iron Nitride Powder

In the present invention, the term “iron nitride powder” means magnetic powder containing at least an Fe₁₆N₂ phase. Iron nitride phases other than the Fe₁₆N₂ phase are not desirably present. This is because, although the crystal magnetic anisotropy of iron nitride (Fe₄N and Fe₃N phases) is about 1×10⁵ erg/cc (1×10⁻² J/cc), Fe₁₆N₂ has a high crystal magnetic anisotropy of 2×10⁶ to 7×10⁶ erg/cc (2×10⁻¹ to 7×10⁻¹ J/cc). Thus, high coercivity can be maintained even with microparticles. This high crystal magnetic anisotropy is due to the crystalline structure of the Fe₁₆N₂ phase. The crystalline structure is a body-centered square crystal with N atoms inserted at regular positions within an octahedral lattice of Fe. The distortion caused by the introduction of N atoms into the lattice is thought to be the causative factor behind the high crystal magnetic anisotropy. The easy axis of magnetization of the Fe₁₆N₂ phase is the C axis extended due to conversion to a nitride.

The shape of the particles containing the Fe₁₆N₂ phase is desirably granular or elliptic. Spherical is preferred. This is because, of the three equivalent directions of α-Fe, which is a cubic crystal, one is selected by conversion to a nitride to serve as the c axis (easy axis of magnetization). If the particle shape were to be acicular, the easy axis of magnetization would be the short axis direction, with particles in the major axis direction being undesirably mixed in. Accordingly, the average value of the aspect ratio of the major axis length/minor axis length is equal to or less than 2 (1 to 2, for example), preferably equal to or less than 1.5 (1 to 1.5, for example).

Generally, the particle diameter is determined by the diameter of the iron particle prior to conversion to a nitride, and is preferably a monodispersion. This is because, in general, medium noise drops in a monodispersion. The particle diameter of the iron nitride magnetic powder having Fe₁₆N₂ as main phase is normally determined by the particle diameter of the iron particles. The particle diameter distribution of the iron particles is desirably a monodispersion. This is because the nitride ratio differs in large particles and small particles, and the magnetic characteristics differ. For this reason as well, the particle diameter distribution of iron nitride magnetic powder is desirably a monodispersion.

The average particle diameter of the iron nitride is desirably 5 to 30 nm n, preferably 5 to 25 nm, more preferably, 8 to 15 nm, and still more preferably, 9 to 11 nm. This is because a small particle diameter results in a large thermal fluctuation effect, causing super paramagnetism that is unsuited to a magnetic recording medium. Due to magnetic viscosity, the coercivity increases during high-speed recording in the head, making it hard to record. On the other hand, when the particle diameter increases, it becomes impossible to decrease the saturation magnetization, causing the coercivity to become excessively high during recording and making it difficult to record. When the particles are large, noise due to particles increases when employed in a magnetic recording medium. The average particle diameter of the iron nitride in the present invention refers to the average particle diameter of the Fe₁₆N₂ phase. When a layer is formed on the surface of Fe₁₆N₂ particles, it refers to the average size of the Fe₁₆N₂ particles without the layer. A layer such as an oxidation inhibiting layer can be optionally formed on the surface of the Fe₁₆N₂ particles.

The particle diameter distribution of the iron nitride is desirably a monodispersion. This is because medium noise generally decreases in a monodispersion. The coefficient of variation of the particle diameter is equal to or less than 15 percent (desirably 2 to 15 percent), preferably equal to or less than 10 percent (desirably 2 to 10 percent). The particle diameter and the coefficient of variation of the particle diameter can be calculated by placing and drying diluted alloy nanoparticles on a Cu 200 mesh on which a carbon film has been adhered, shooting a negative at 100,000-fold magnification by TEM (1200EX made by JEOL), measuring the negative with a particle diameter measuring device (KS-300 made by Carl Zeiss), and calculating the values from the arithmetic average particle diameter measured.

The content of nitrogen relative to iron in the particles contained in the Fe₁₆N₂ phase is desirably 1.0 to 20.0 atomic percent, preferably 5.0 to 18.0 atomic percent, and more preferably, 8.0 to 15.0 atomic percent. This is because when the amount of nitrogen becomes excessively low, the quantity of Fe₁₆N₂ phase that forms decreases. An increase in coercivity is caused by the distortion due to conversion to a nitride. When the quantity of nitrogen becomes excessively low, coercivity decreases. When too much nitrogen is present, the Fe₁₆N₂ phase becomes a semistable phase, becoming other nitrides that are stable phases when decomposed. As a result, the saturation magnetization decreases excessively.

In the present invention, the term “coefficient of variation of the particle diameter” means the value that is obtained by calculating the standard deviation of the particle diameter distribution for the equivalent circular diameter, and dividing it by the average particle diameter. The term “coefficient of variation of the composition” means the value that is obtained by calculating the standard deviation of the composition distribution of alloy nanoparticles in the same manner as for the coefficient of variation of the particle diameter, and dividing it by the average composition. Such values are multiplied by 100 and indicated as percentages in the present invention.

The average particle diameter and the coefficient of variation in the particle diameter can be calculated by placing and drying diluted alloy nanoparticles on a Cu 200 mesh on which a carbon film has been adhered, shooting a negative at 100,000-fold magnification by TEM (1200EX made by JEOL), measuring the negative with a particle diameter measuring device (KS-300 made by Carl Zeiss), and calculating the values from the arithmetic average particle diameter measured.

The surface of the iron nitride powder comprising the main phase of the Fe₁₆N₂ is desirably covered with an oxide film. This is because Fe₁₆N₂ microparticles oxidize readily and require handling in a nitrogen atmosphere.

The oxide film desirably contains rare earth elements and/or elements selected from among silicon and aluminum. Thus, the same particle surface as the conventional metal particles with main components in the form of iron and Co is present, with high compatibility with the steps for handling metal particles. Y, La, Ce, Pr, Nd, Sm, Tb, Dy, and Gd are desirably employed as the rare earth elements, with the use of Y being preferred from the perspective of dispersibility.

Further, in addition to silicon and aluminum, boron and phosphorus can be incorporated as needed. Further, carbon, calcium, magnesium, zirconium, barium, strontium, and the like can be incorporated as effective elements. The use of these other elements with rare earth elements and/or silicon and aluminum can result in better shape retention and dispersion.

In the composition of the surface compound layer, the total content of rare earth elements or boron, silicon, aluminum or phosphorus relative to iron is desirably 0.1 to 40.0 atomic percent, preferably 1.0 to 30.0 atomic percent, and more preferably, 3.0 to 25.0 atomic percent. When the quantity of these elements is excessively low, formation of the surface compound layer becomes difficult. Not only does the magnetic anisotropy of the magnetic powder decrease, but oxidation stabilization tends to deteriorate. When the quantity of these elements is excessively high, the saturation magnetization tends to drop excessively.

The oxide film is desirably 1 to 5 nm, preferably 2 to 3 nm, in thickness. When it falls below this range, oxidation stabilization tends to decrease. When too thick, the particle size sometimes tends not to substantially decrease.

As a magnetic characteristic of the iron nitride powder comprising the main phase of Fe₁₆N₂, the coercivity (Hc) is desirably 79.6 to 318.4 kA/m (1,000 to 4,000 Oe), preferably 159.2 to 278.6 kA/m (2,000 to 3,500 Oe), and more preferably, 197.5 to 237 kA/m (2,500 to 3,000 Oe). This is because when the Hc is low, in the case of in-plane recording, for example, a given bit tends to be affected by bits recorded adjacent to it, sometimes compromising suitability to high recording density. When too high, recording becomes difficult.

The “Ms·V” of the iron nitride powder is desirably 5.2×10⁻¹⁶ to 6.5×10⁻¹⁶. The saturation magnetization Ms in the “Ms·V” can be measured using a vibrating magnetic measuring apparatus (VSM), for example. The volume V can be calculated by observing the particles by a transmission electron microscope (TEM), calculating the particle diameter of the Fe₁₆N₂ phase, and converting it to a volume.

The saturation magnetization of the iron nitride powder is desirably 80 to 160 Am²/kg (80 to 160 emu/g), preferably 80 to 120 Am²/kg (80 to 120 emu/g). This is because when too low, the signal sometimes becomes excessively weak, and when too high, in the case of in-plane recording, for example, a given bit tends to affect the bits recorded adjacent to it, compromising suitability to high recording density. A squareness of 0.6 to 0.9 is desirable.

In the iron nitride powder, the BET specific surface area is desirably 40 to 100 m²/g. This is because when the BET specific surface area is excessively low, the particle size increases, noise due to particles increases when applied to the magnetic recording medium, the surface smoothness of the magnetic layer decreases, and reproduction output tends to drop. When the BET specific surface area is excessively high, the particles comprising the Fe₁₆N₂ phase tend to aggregate, it becomes difficult to obtain a uniform dispersion, and it becomes difficult to obtain a smooth surface.

Iron nitride suitable for use in the present invention can be synthesized by known methods, and may be obtained as a commercial product. Reference can be made to Japanese Unexamined Patent Publication (KOKAI) No. 2007-36183 or the like for details on iron nitride suitable for use in the present invention. The content of the above publication is expressly incorporated herein by reference in its entirety.

(iii) Ferromagnetic Metal Powder

The ferromagnetic metal powder employed in the magnetic layer is not specifically limited, but preferably a ferromagnetic metal power comprised primarily of α-Fe. In addition to prescribed atoms, the following atoms can be contained in the ferromagnetic metal powder: Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B and the like. Particularly, incorporation of at least one of the following in addition to α-Fe is desirable: Al, Si, Ca, Y, Ba, La, Nd, Co, Ni, and B. Incorporation of at least one selected from the group consisting of Co, Y and Al is particularly preferred. The Co content preferably ranges from 0 to 40 atom percent, more preferably from 15 to 35 atom percent, further preferably from 20 to 35 atom percent with respect to Fe. The content of Y preferably ranges from 1.5 to 12 atom percent, more preferably from 3 to 10 atom percent, further preferably from 4 to 9 atom percent with respect to Fe. The Al content preferably ranges from 1.5 to 12 atom percent, more preferably from 3 to 10 atom percent, further preferably from 4 to 9 atom percent with respect to Fe.

These ferromagnetic metal powders may be pretreated prior to dispersion with dispersing agents, lubricants, surfactants, antistatic agents, and the like, described further below. Specific examples are described in Japanese Examined Patent Publication (KOKOKU) Showa Nos. 44-14090, 45-18372, 47-22062, 47-22513, 46-28466, 46-38755, 47-4286, 47-12422, 47-17284, 47-18509, 47-18573, 39-10307, and 46-39639; and U.S. Pat. Nos. 3,026,215, 3,031,341, 3,100,194, 3,242,005, and 3,389,014.

The ferromagnetic metal powder may contain a small quantity of hydroxide or oxide. Ferromagnetic metal powders obtained by known manufacturing methods may be employed. The following are examples of methods of manufacturing ferromagnetic metal powders: methods of reduction with compound organic acid salts (chiefly oxalates) and reducing gases such as hydrogen; methods of reducing iron oxide with a reducing gas such as hydrogen to obtain Fe or Fe—Co particles or the like; methods of thermal decomposition of metal carbonyl compounds; methods of reduction by addition of a reducing agent such as sodium boron hydride, hypophosphite, or hydrazine to an aqueous solution of ferromagnetic metal; and methods of obtaining powder by vaporizing a metal in a low-pressure inert gas. Any one from among the known method of slow oxidation, that is, immersing the ferromagnetic metal powder thus obtained in an organic solvent and drying it; the method of immersing the ferromagnetic metal powder in an organic solvent, feeding in an oxygen-containing gas to form a surface oxide film, and then conducting drying; and the method of adjusting the partial pressures of oxygen gas and an inert gas without employing an organic solvent to form a surface oxide film, may be employed.

The specific surface area by BET method of the ferromagnetic metal powder employed in the magnetic layer is preferably 45 to 100 m²/g, more preferably 50 to 80 m²/g. At 45 m²/g and above, low noise is achieved. At 100 m²/g and below, good surface properties are achieved. The crystallite size of the ferromagnetic metal powder is preferably 80 to 180 Angstroms, more preferably 100 to 180 Angstroms, and still more preferably, 110 to 175 Angstroms. The major axis length of the ferromagnetic metal powder is preferably equal to or greater than 0.01 μm and equal to or less than 0.15 μm, more preferably equal to or greater than 0.02 μm and equal to or less than 0.15 μm, and still more preferably, equal to or greater than 0.03 μm and equal to or less than 0.12 μm. The acicular ratio of the ferromagnetic metal powder is preferably equal to or greater than 3 and equal to or less than 15, more preferably equal to or greater than 5 and equal to or less than 12. The as of the ferromagnetic metal powder is preferably 100 to 180 A·m²/kg, more preferably 110 to 170 A·m²/kg, and still more preferably, 125 to 160 A·m²/kg. The coercivity of the ferromagnetic metal powder is preferably 2,000 to 3,500 Oe (160 to 280 kA/m), more preferably 2,200 to 3,000 Oe (176 to 240 kA/m).

The moisture content of the ferromagnetic metal powder is desirably 0.01 to 2 percent. The moisture content of the ferromagnetic metal powder is desirably optimized based on the type of binder. The pH of the ferromagnetic metal powder is desirably optimized depending on what is combined with the binder. A range of 4 to 12 can be established, with 6 to 10 being preferred. As needed, the ferromagnetic metal powder can be surface treated with Al, Si, P, or an oxide thereof. The quantity can be set to 0.1 to 10 percent of the ferromagnetic metal powder. When applying a surface treatment, the quantity of a lubricant such as a fatty acid that is adsorbed is desirably not greater than 100 mg/m². The ferromagnetic metal powder will sometimes contain inorganic ions such as soluble Na, Ca, Fe, Ni, or Sr. These are desirably substantially not present, but seldom affect characteristics at equal to or less than 200 ppm. The ferromagnetic metal powder employed in the present invention desirably has few voids; the level is preferably equal to or less than 20 volume percent, more preferably equal to or less than 5 volume percent. As stated above, so long as the particle size characteristics are satisfied, the ferromagnetic metal powder may be acicular, rice grain-shaped, or spindle-shaped. The SFD of the ferromagnetic metal powder itself is desirably low, with equal to or less than 0.8 being preferred. The Hc distribution of the ferromagnetic metal powder is desirably kept low. When the SFD is equal to or lower than 0.8, good electromagnetic characteristics are achieved, output is high, and magnetic inversion is sharp, with little peak shifting, in a manner suited to high-density digital magnetic recording. To keep the Hc low, the methods of improving the particle size distribution of goethite in the ferromagnetic metal powder and preventing sintering may be employed.

Known techniques regarding binders, lubricants, dispersion agents, additives, solvents, dispersion methods and the like for magnetic layer, nonmagnetic layer and backcoat layer optionally provided can be suitably applied in the magnetic recording medium of the present invention. In particular, known techniques regarding the quantity and types of binders, and quantity added and types of additives and dispersion agents can be applied.

Binder

Conventionally known thermoplastic resins, thermosetting resins, reactive resins, and mixtures of the same can be employed as the binder. A thermoplastic resin having a glass transition temperature of −100 to 150° C., a number average molecular weight of 1,000 to 200,000, desirably 10,000 to 100,000, and a degree of polymerization of about 50 to 1,000 can be employed. As set forth above, the use of a thermosetting resin in the nonmagnetic layer and conducting thermoprocessing can increase the resistance to solvent of the nonmagnetic layer and reduce the roughness of the interface between the magnetic layer and the nonmagnetic layer, thereby controlling surface glossiness.

Examples thereof are polymers and copolymers comprising structural units in the form of vinyl chloride, vinyl acetate, vinyl alcohol, maleic acid, acrylic acid, acrylic acid esters, vinylidene chloride, acrylonitrile, methacrylic acid, methacrylic acid esters, styrene, butadiene, ethylene, vinyl butyral, vinyl acetal, and vinyl ether; polyurethane resins; and various rubber resins. Further, examples of thermosetting resins and reactive resins are phenol resins, epoxy resins, polyurethane cured resins, urea resins, melamine resins, alkyd resins, acrylic reactive resins, formaldehyde resins, silicone resins, epoxy polyamide resins, mixtures of polyester resins and isocyanate prepolymers, mixtures of polyester polyols and polyisocyanates, and mixtures of polyurethane and polyisocyanates. These resins are described in detail in Handbook of Plastics published by Asakura Shoten. It is also possible to employ known electron beam-cured resins in each layer. Examples and manufacturing methods of such resins are described in Japanese Unexamined Patent Publication (KOKAI) Showa No. 62-256219. The contents of the above publications are expressly incorporated herein by reference in their entirety. The above-listed resins may be used singly or in combination. Preferred resins are combinations of polyurethane resin and at least one member selected from the group consisting of vinyl chloride resin, vinyl chloride—vinyl acetate copolymers, vinyl chloride—vinyl acetate—vinyl alcohol copolymers, and vinyl chloride—vinyl acetate—maleic anhydride copolymers, as well as combinations of the same with polyisocyanate.

Known structure of polyurethane resins may be employed, such as polyester polyurethane, polyether polyurethane, polyether polyester polyurethane, polycarbonate polyurethane, polyester polycarbonate polyurethane, and polycaprolactone polyurethane. A binder obtained by incorporating as needed one or more polar groups selected from among —COOM, —SO₃M, —OSO₃M, —P═O(OM)₂, and —O—P═O(OM)₂ (where M denotes a hydrogen atom or an alkali metal base), —OH, —NR₂, —N⁺R₃ (where R denotes a hydrocarbon group), epoxy group, —SH, and —CN into any of the above-listed binders by copolymerization or addition reaction to improve dispersion properties and durability is desirably employed. The quantity of such a polar group preferably ranges from 10⁻¹ to 10⁻⁸ mol/g, more preferably from 10⁻² to 10⁻⁶ mol/g.

Specific examples of the binders are VAGH, VYHH, VMCH, VAGF, VAGD, VROH, VYES, VYNC, VMCC, XYHL, XYSG, PKHH, PKHJ, PKHC, and PKFE from Dow Chemical Company; MPR-TA, MPR-TA5, MPR-TAL, MPR-TSN, MPR-TMF, MPR-TS, MPR-TM, and MPR-TAO from Nisshin Kagaku Kogyo K. K.; 1000W, DX80, DX81, DX82, DX83, and 100FD from Denki Kagaku Kogyo K. K.; MR-104, MR-105, MR110, MR100, MR555, and 400X-110A from Nippon Zeon Co., Ltd.; Nippollan N2301, N2302, and N2304 from Nippon Polyurethane Co., Ltd.; Pandex T-5105, T-R3080, T-5201, Burnock D-400, D-210-80, Crisvon 6109, and 7209 from Dainippon Ink and Chemicals Incorporated; Vylon UR8200, UR8300, UR-8700, RV530, and RV280 from Toyobo Co., Ltd.; Daipheramine 4020, 5020, 5100, 5300, 9020, 9022, and 7020 from Dainichiseika Color & Chemicals Mfg. Co., Ltd.; MX5004 from Mitsubishi Chemical Corporation; Sanprene SP-150 from Sanyo Chemical Industries, Ltd.; and Saran F310 and F210 from Asahi Chemical Industry Co., Ltd.

The quantity of binder employed in the magnetic layer and the nonmagnetic layer ranges from, for example, 5 to 50 mass percent, preferably from 10 to 30 mass percent, relative to the nonmagnetic powder or magnetic powder. When employing vinyl chloride resin, the quantity added is preferably from 5 to 30 mass percent; when employing polyurethane resin, from 2 to 20 mass percent; and when employing polyisocyanate, from 2 to 20 mass percent. They are preferably employed in combination. However, for example, when head corrosion occurs due to the release of trace amounts of chlorine, polyurethane alone or just polyurethane and isocyanate may be employed. When polyurethane is employed, polyurethanes suitable for use are those having a glass transition temperature ranging from −50 to 150° C., preferably from 0 to 100° C.; a elongation at break preferably ranging from 100 to 2,000 percent; a stress at break ranging from 0.05 to 10 kg/mm² (0.49 to 98 MPa); and a yield point ranging from 0.05 to 10 kg/mm² (0.49 to 98 MPa).

Examples of polyisocyanates are tolylene diisocyanate, 4,4′-diphenylmethane diisocyanate, hexamethylene diisocyanate, xylylene diisocyanate, napthylene-1,5-diisocyanate, o-toluidine diisocyanate, isophorone diisocyanate, triphenylmethane triisocyanate, and other isocyanates; products of these isocyanates and polyalcohols; polyisocyanates produced by condensation of isocyanates; and the like. These isocyanates are commercially available under the following trade names, for example: Coronate L, Coronate HL, Coronate 2030, Coronate 2031, Millionate MR and Millionate MTL manufactured by Nippon Polyurethane Industry Co. Ltd.; Takenate D-102, Takenate D-110N, Takenate D-200 and Takenate D-202 manufactured by Takeda Chemical Industries Co., Ltd.; and Desmodule L, Desmodule IL, Desmodule N and Desmodule HL manufactured by Sumitomo Bayer Co., Ltd. They can be used in each layer singly or in combinations of two or more by exploiting differences in curing reactivity.

Additives may be added to the magnetic layer as needed. Examples of such additives are: abrasives, lubricants, dispersing agents, dispersing adjuvants, antifungal agents, antistatic agents, oxidation inhibitors, solvents, and carbon black. Examples of additives are: molybdenum disulfide, tungsten disulfide, graphite, boron nitride, graphite fluoride, silicone oil, polar group-comprising silicone, fatty acid-modified silicone, fluorosilicone, fluoroalcohols, fluoroesters, polyolefin, polyglycol, polyphenyl ether, phenyl phosphonic acid, benzyl phosphonic acid, phenethyl phosphonic acid, α-methylbenzylphosphonic acid, 1-methyl-1-phenethylphosphonic acid, diphenylmethylphosphonic acid, biphenylphosphonic acid, benzylphenylphosphonic acid, α-cumylphosphonic acid, toluoylphosphonic acid, xylylphosphonic acid, ethylphenylphosphonic acid, cumenylphosphonic acid, propylphenylphosphonic acid, butylphenylphosphonic acid, heptylphenylphosphonic acid, octylphenylphosphonic acid, nonylphenylphosphonic acid, other aromatic ring-comprising organic phosphonic acids, alkali metal salts thereof, octylphosphonic acid, 2-ethylhexylphosphonic acid, isooctylphosphonic acid, isononylphosphonic acid, isodecylphosphonic acid, isoundecylphosphonic acid, isododecylphosphonic acid, isohexadecylphosphonic acid, isooctadecylphosphonic acid, isoeicosylphosphonic acid, other alkyl phosphonoic acid, alkali metal salts thereof, phenyl phosphoric acid, benzyl phosphoric acid, phenethyl phosphoric acid, α-methylbenzylphosphoric acid, 1-methyl-1-phenethylphosphoric acid, diphenylmethylphosphoric acid, diphenyl phosphoric acid, benzylphenyl phosphoric acid, α-cumyl phosphoric acid, toluoyl phosphoric acid, xylyl phosphoric acid, ethylphenyl phosphoric acid, cumenyl phosphoric acid, propylphenyl phosphoric acid, butylphenyl phosphoric acid, heptylphenyl phosphoric acid, octylphenyl phosphoric acid, nonylphenyl phosphoric acid, other aromatic phosphoric esters, alkali metal salts thereof, octyl phosphoric acid, 2-ethylhexylphosphoric acid, isooctyl phosphoric acid, isononyl phosphoric acid, isodecyl phosphoric acid, isoundecyl phosphoric acid, isododecyl phosphoric acid, isohexadecyl phosphoric acid, isooctyldecyl phosphoric acid, isoeicosyl phosphoric acid, other alkyl ester phosphoric acids, alkali metal salts thereof, alkylsulfonic acid ester, alkali metal salts thereof, fluorine-containing alkyl sulfuric acid esters, alkali metal salts thereof, lauric acid, myristic acid, palmitic acid, stearic acid, behenic acid, butyl stearate, oleic acid, linolic acid, linoleic acid, elaidic acid, erucic acid, other monobasic fatty acids comprising 10 to 24 carbon atoms (which may contain an unsaturated bond or be branched), metal salts thereof, butyl stearate, octyl stearate, amyl stearate, isooctyl stearate, octyl myristate, butyl laurate, butoxyethyl stearate, anhydrosorbitan monostearate, anhydrosorbitan tristearate, other monofatty esters, difatty esters, or polyfatty esters comprising a monobasic fatty acid having 10 to 24 carbon atoms (which may contain an unsaturated bond or be branched) and any one from among a monohydric, dihydric, trihydric, tetrahydric, pentahydric or hexahydric alcohol having 2 to 22 carbon atoms (which may contain an unsaturated bond or be branched), alkoxyalcohol having 12 to 22 carbon atoms (which may contain an unsaturated bond or be branched) or a monoalkyl ether of an alkylene oxide polymer, fatty acid amides with 2 to 22 carbon atoms, and aliphatic amines with 8 to 22 carbon atoms. Compounds having aralkyl groups, aryl groups, or alkyl groups substituted with groups other than hydrocarbon groups, such as nitro groups, F, Cl, Br, CF₃, CCl₃, CBr₃, and other halogen-containing hydrocarbons in addition to the above hydrocarbon groups, may also be employed.

It is also possible to employ nonionic surfactants such as alkylene oxide-based surfactants, glycerin-based surfactants, glycidol-based surfactants and alkylphenolethylene oxide adducts; cationic surfactants such as cyclic amines, ester amides, quaternary ammonium salts, hydantoin derivatives, heterocycles, phosphoniums, and sulfoniums; anionic surfactants comprising acid groups, such as carboxylic acid, sulfonic acid, phosphoric acid, sulfuric ester groups, and phosphoric ester groups; and ampholytic surfactants such as amino acids, amino sulfonic acids, sulfuric or phosphoric esters of amino alcohols, and alkyl betaines. Details of these surfactants are described in A Guide to Surfactants (published by Sangyo Tosho K.K.).

The above-described lubricants, antistatic agents and the like need not be 100 percent pure and may contain impurities, such as isomers, unreacted material, by-products, decomposition products, and oxides in addition to the main components. These impurities are preferably comprised equal to or less than 30 mass percent, and more preferably equal to or less than 10 mass percent.

Specific examples of these additives are: NAA-102, hydrogenated castor oil fatty acid, NAA-42, Cation SA, Nymeen L-201, Nonion E-208, Anon BF and Anon LG manufactured by NOF Corporation; FAL-205 and FAL-123 manufactured by Takemoto Oil & Fat Co., Ltd.; NJLUB OL manufactured by New Japan Chemical Co. Ltd.; TA-3 manufactured by Shin-Etsu Chemical Co. Ltd.; Amide P manufactured by Lion Corporation; Duomine TDO manufactured by Lion Corporation; BA-41G manufactured by Nisshin OilliO, Ltd.; and Profan 2012E, Newpole PE61 and Ionet MS-400 manufactured by Sanyo Chemical Industries, Ltd.

Carbon black may be added to the magnetic layer as needed. Examples of types of carbon black that are suitable for use in the magnetic layer are: furnace black for rubber, thermal for rubber, black for coloring, and acetylene black. It is preferable that the specific surface area is 5 to 500 m²/g, the DBP oil absorption capacity is 10 to 400 ml/100 g, the particle diameter is 5 to 300 nm, the pH is 2 to 10, the moisture content is 0.1 to 10 percent, and the tap density is 0.1 to 1 g/ml.

Specific examples of carbon black are: BLACK PEARLS 2000, 1300, 1000, 900, 905, 800, 700 and VULCAN XC-72 from Cabot Corporation; #80, #60, #55, #50 and #35 manufactured by Asahi Carbon Co., Ltd.; #2400B, #2300, #900, #1000, #30, #40 and #10B from Mitsubishi Chemical Corporation; CONDUCTEX SC, RAVEN 150, 50, 40, 15 and RAVEN MT-P from Columbia Carbon Co., Ltd.; and Ketjen Black EC from Ketjen Black International Co., Ltd. The carbon black employed may be surface-treated with a dispersant or grafted with resin, or have a partially graphite-treated surface. The carbon black may be dispersed in advance into the binder prior to addition to the magnetic layer coating liquid. These carbon blacks may be used singly or in combination. When employing carbon black, the quantity preferably ranges from 0.1 to 30 mass percent with respect to the mass of the ferromagnetic powder. In the magnetic layer, carbon black can work to prevent static, reduce the coefficient of friction, impart light-blocking properties, enhance film strength, and the like; the properties vary with the type of carbon black employed. Accordingly, the type, quantity, and combination of carbon blacks employed in the present invention may be determined separately for the magnetic layer and the nonmagnetic layer based on the objective and the various characteristics stated above, such as particle size, oil absorption capacity, electrical conductivity, and pH, and be optimized for each layer. For example, the Carbon Black Handbook compiled by the Carbon Black Association may be consulted for types of carbon black suitable for use in the magnetic layer.

Abrasive

Known materials chiefly having a Mohs' hardness of equal to or greater than 6 may be employed either singly or in combination as abrasives. These include: α-alumina with an α-conversion rate of equal to or greater than 90 percent, β-alumina, silicon carbide, chromium oxide, cerium oxide, α-iron oxide, corundum, synthetic diamond, silicon nitride, silicon carbide titanium carbide, titanium oxide, silicon dioxide, and boron nitride. Complexes of these abrasives (obtained by surface treating one abrasive with another) may also be employed. There are cases in which compounds or elements other than the primary compound are contained in these abrasives; the effect does not change so long as the content of the primary compound is equal to or greater than 90 percent. The particle size of the abrasive is preferably 0.01 to 2 micrometers. To enhance electromagnetic characteristics, a narrow particle size distribution is desirable. Abrasives of differing particle size may be incorporated as needed to improve durability; the same effect can be achieved with a single abrasive as with a wide particle size distribution. It is preferable that the tap density is 0.3 to 2 g/cc, the moisture content is 0.1 to 5 percent, the pH is 2 to 11, and the specific surface area is 1 to 30 m²/g. The shape of the abrasive may be acicular, spherical, cubic, plate-shaped or the like. However, a shape comprising an angular portion is desirable due to high abrasiveness. Specific examples are AKP-12, AKP-15, AKP-20, AKP-30, AKP-50, HIT-20, HIT-30, HIT-55, HIT-60, HIT-70, HIT-80, and HIT-100 made by Sumitomo Chemical Co., Ltd.; ERC-DBM, HP-DBM, and HPS-DBM made by Reynolds Corp.; WA10000 made by Fujimi Abrasive Corp.; UB20 made by Uemura Kogyo Corp.; G-5, Chromex U2, and Chromex U1 made by Nippon Chemical Industrial Co., Ltd.; TF100 and TF140 made by Toda Kogyo Corp.; Beta Random Ultrafine made by Ibiden Co., Ltd.; and B-3 made by Showa Kogyo Co., Ltd. These abrasives may be added as needed to the nonmagnetic layer. Addition of abrasives to the nonmagnetic layer can be done to control surface shape, control how the abrasive protrudes, and the like. The particle diameter and quantity of the abrasives added to the magnetic layer and nonmagnetic layer should be set to optimal values.

Known organic solvents can be used. Examples of the organic solvents are ketones such as acetone, methyl ethyl ketone, methyl isobutyl ketone, diisobutyl ketone, cyclohexanone, isophorone, and tetrahydrofuran; alcohols such as methanol, ethanol, propanol, butanol, isobutyl alcohol, isopropyl alcohol, and methylcyclohexanol; esters such as methyl acetate, butyl acetate, isobutyl acetate, isopropyl acetate, ethyl lactate, and glycol acetate; glycol ethers such as glycol dimethyl ether, glycol monoethyl ether, and dioxane; aromatic hydrocarbons such as benzene, toluene, xylene, cresol, and chlorobenzene; chlorinated hydrocarbons such as methylene chloride, ethylene chloride, carbon tetrachloride, chloroform, ethylene chlorohydrin, and dichlorobenzene; N,N-dimethylformamide; and hexane; these may be employed in any ratio.

These organic solvents need not be 100 percent pure and may contain impurities such as isomers, unreacted materials, by-products, decomposition products, oxides and moisture in addition to the main components. The content of these impurities is preferably equal to or less than 30 mass percent, more preferably equal to or less than 10 mass percent. Preferably the same type of organic solvent is employed in the magnetic layer and in the nonmagnetic layer. However, the amount added may be varied. The stability of coating is increased by using a solvent with a high surface tension (such as cyclohexanone or dioxane) in the nonmagnetic layer. Specifically, it is important that the arithmetic mean value of the upper layer solvent composition be not less than the arithmetic mean value of the nonmagnetic layer solvent composition. To improve dispersion properties, a solvent having a somewhat strong polarity is desirable. It is desirable that solvents having a dielectric constant equal to or higher than 15 are comprised equal to or higher than 50 mass percent of the solvent composition. Further, the dissolution parameter is desirably 8 to 11.

The types and quantities of dispersing agents, lubricants, and surfactants employed in the magnetic layer may differ from those employed in the nonmagnetic layer, described further below, in the present invention. For example (the present invention not being limited to the embodiments given herein), a dispersing agent usually has the property of adsorbing or bonding by means of a polar group. In the magnetic layer, the dispersing agent adsorbs or bonds by means of the polar group primarily to the surface of the ferromagnetic metal powder, and in the nonmagnetic layer, primarily to the surface of the nonmagnetic powder. It is surmised that once an organic phosphorus compound has adsorbed or bonded, it tends not to dislodge readily from the surface of a metal, metal compound, or the like. Accordingly, the surface of a ferromagnetic metal powder or the surface of a nonmagnetic powder becomes covered with the alkyl group, aromatic groups, and the like. This enhances the compatibility of the ferromagnetic metal powder or nonmagnetic powder with the binder resin component, further improving the dispersion stability of the ferromagnetic metal powder or nonmagnetic powder. Further, lubricants are present in a free state. Thus, it is conceivable to use fatty acids with different melting points in the nonmagnetic layer and magnetic layer to control seepage onto the surface, employ esters with different boiling points and polarity to control seepage onto the surface, regulate the quantity of the surfactant to enhance coating stability, and employ a large quantity of lubricant in the nonmagnetic layer to enhance the lubricating effect. All or some part of the additives employed in the present invention can be added in any of the steps during the manufacturing of coating liquids for the magnetic layer and nonmagnetic layer. For example, there are cases where they are mixed with the ferromagnetic powder prior to the kneading step; cases where they are added during the step in which the ferromagnetic powder, binder, and solvent are kneaded; cases where they are added during the dispersion step; cases where they are added after dispersion; and cases where they are added directly before coating.

Nonmagnetic Layer

Details of the nonmagnetic layer will be described below. The magnetic recording medium of the present invention comprises a nonmagnetic layer comprising a nonmagnetic powder and a binder on the nonmagnetic support. Both organic and inorganic substances may be employed as the nonmagnetic powder in the nonmagnetic layer. Carbon black may also be employed. Examples of inorganic substances are metals, metal oxides, metal carbonates, metal sulfates, metal nitrides, metal carbides, and metal sulfides.

Specifically, titanium oxides such as titanium dioxide, cerium oxide, tin oxide, tungsten oxide, ZnO, ZrO₂, SiO₂, Cr₂O₃, α-alumina with an α-conversion rate of 90 to 100 percent, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide may be employed singly or in combinations of two or more. α-iron oxide and titanium oxide are preferred.

The nonmagnetic powder may be acicular, spherical, polyhedral, or plate-shaped. The crystallite size of the nonmagnetic powder preferably ranges from 4 nm to 500 nm, more preferably from 40 to 100 nm. A crystallite size falling within a range of 4 mm to 500 nm is desirable in that it facilitates dispersion and imparts a suitable surface roughness. The average particle diameter of the nonmagnetic powder preferably ranges from 5 nm to 500 nm. As needed, nonmagnetic powders of differing average particle diameter may be combined; the same effect may be achieved by broadening the average particle distribution of a single nonmagnetic powder. The particularly preferred average particle diameter of the nonmagnetic powder ranges from 10 to 200 nm. Within a range of 5 nm to 500 nm, dispersion is good and a nonmagnetic layer with good surface roughness can be achieved; the above range is preferred.

The specific surface area of the nonmagnetic powder ranges from, for example, 1 to 150 m²/g, preferably from 20 to 120 m²/g, and more preferably from 50 to 100 m²/g. Within the specific surface area ranging from 1 to 150 m²/g, suitable surface roughness can be achieved and dispersion is possible with the desired quantity of binder; the above range is preferred. Oil absorption capacity using dibutyl phthalate (DBP) preferably ranges from 5 to 100 mL/100 g, more preferably from 10 to 80 mL/100 g, and further preferably from 20 to 60 mL/100 g. The specific gravity ranges from, for example, 1 to 12, preferably from 3 to 6. The tap density ranges from, for example, 0.05 to 2 g/mL, preferably from 0.2 to 1.5 g/mL. A tap density falling within a range of 0.05 to 2 g/mL can reduce the amount of scattering particles, thereby facilitating handling, and tends to prevent solidification to the device. The pH of the nonmagnetic powder preferably ranges from 2 to 11, more preferably from 6 to 9. When the pH falls within a range of 2 to 11, the coefficient of friction does not become high at high temperature or high humidity or due to the freeing of fatty acids. The moisture content of the nonmagnetic powder ranges from, for example, 0.1 to 5 mass percent, preferably from 0.2 to 3 mass percent, and more preferably from 0.3 to 1.5 mass percent. A moisture content falling within a range of 0.1 to 5 mass percent is desirable because it can produce good dispersion and yield a stable coating viscosity following dispersion. An ignition loss of equal to or less than 20 mass percent is desirable and nonmagnetic powders with low ignition losses are desirable.

When the nonmagnetic powder is an inorganic powder, the Mohs' hardness is preferably 4 to 10. Durability can be ensured if the Mohs' hardness ranges from 4 to 10. The stearic acid (SA) adsorption capacity of the nonmagnetic powder preferably ranges from 1 to 20 μmol/m², more preferably from 2 to 15 μmol/m². The heat of wetting in 25° C. water of the nonmagnetic powder is preferably within a range of 200 to 600 erg/cm² (200 to 600 mJ/m²). A solvent with a heat of wetting within this range may also be employed. The quantity of water molecules on the surface at 100 to 400° C. suitably ranges from 1 to 10 pieces per 100 Angstroms. The pH of the isoelectric point in water preferably ranges from 3 to 9. The surface of these nonmagnetic powders preferably contains Al₂O₃, SiO₂, TiO₂, ZrO₂, SnO₂, Sb₂O₃, and ZnO by conducting surface treatment. The surface-treating agents of preference with regard to dispersibility are Al₂O₃, SiO₂, TiO₂, and ZrO₂, and Al₂O₃, SiO₂ and ZrO₂ are further preferable. They may be employed singly or in combination. Depending on the objective, a surface-treatment coating layer with a coprecipitated material may also be employed, the method which comprises a first alumina coating and a second silica coating thereover or the reverse method thereof may also be adopted. Depending on the objective, the surface-treatment coating layer may be a porous layer, with homogeneity and density being generally desirable.

Specific examples of nonmagnetic powders suitable for use in the nonmagnetic layer are: Nanotite from Showa Denko K. K.; HIT-100 and ZA-G1 from Sumitomo Chemical Co., Ltd.; DPN-250, DPN-250BX, DPN-245, DPN-270BX, DPN-550BX and DPN-550RX from Toda Kogyo Corp.; titanium oxide TTO-51B, TTO-55A, TTO-55B, TTO-55C, TTO-55S, TTO-55D, SN-100, MJ-7, α-iron oxide E270, E271 and E300 from Ishihara Sangyo Co., Ltd.; STT-4D, STT-30D, STT-30 and STT-65C from Titan Kogyo K. K.; MT-1000S, MT-100T, MT-150W, MT-500B, T-600B, T-100F and T-500HD from Tayca Corporation. Examples are: FINEX-25, BF-1, BF-10, BF-20 and ST-M from Sakai Chemical Industry Co., Ltd.; DEFIC-Y and DEFIC-R from Dowa Mining Co., Ltd.; AS2BM and TiO2P25 from Nippon Aerogil; 100A and 500A from Ube Industries, Ltd.; Y-LOP from Titan Kogyo K. K.; and sintered products of the same. Particular preferable nonmagnetic powders are titanium dioxide and α-iron oxide.

Carbon black may be combined with nonmagnetic powder in the nonmagnetic layer to reduce surface resistivity, reduce light transmittance, and achieve a desired micro-Vickers hardness. The micro-Vickers hardness of the nonmagnetic layer is normally 25 to 60 kg/mm² (245 to 588 MPa), desirably 30 to 50 kg/mm² (294 to 490 MPa) to adjust head contact. It can be measured with a thin film hardness meter (HMA-400 made by NEC Corporation) using a diamond triangular needle with a tip radius of 0.1 micrometer and an edge angle of 80 degrees as indenter tip. “Techniques for evaluating thin-film mechanical characteristics,” Realize Corp. can be referred to for details. The light transmittance is generally standardized to an infrared absorbance at a wavelength of about 900 nm equal to or less than 3 percent. For example, in VHS magnetic tapes, it has been standardized to equal to or less than 0.8 percent. To this end, furnace black for rubber, thermal black for rubber, black for coloring, acetylene black and the like may be employed.

The specific surface area of the carbon black employed in the nonmagnetic layer is, for example, 100 to 500 m²/g, preferably 150 to 400 m²/g. The DBP oil absorption capability is, for example, 20 to 400 mL/100 g, preferably 30 to 200 mL/100 g. The particle diameter of the carbon black is, for example, 5 to 80 nm, preferably 10 to 50 nm, and more preferably, 10 to 40 nm. It is preferable that the pH of the carbon black is 2 to 10, the moisture content is 0.1 to 10 percent, and the tap density is 0.1 to 1 g/mL.

Specific examples of types of carbon black employed in the nonmagnetic layer are: BLACK PEARLS 2000, 1300, 1000, 900, 800, 880, 700 and VULCAN XC-72 from Cabot Corporation; #3050B, #3150B, #3250B, #3750B, #3950B, #950, #650B, #970B, #850B and MA-600 from Mitsubishi Chemical Corporation; CONDUCTEX SC, RAVEN 8800, 8000, 7000, 5750, 5250, 3500, 2100, 2000, 1800, 1500, 1255 and 1250 from Columbia Carbon Co., Ltd.; and Ketjen Black EC from Ketjen Black International Co., Ltd.

The carbon black employed may be surface-treated with a dispersant or grafted with resin, or have a partially graphite-treated surface. The carbon black may be dispersed in advance into the binder prior to addition to the coating liquid. The quantity of the carbon black is preferably within a range not exceeding 50 mass percent of the inorganic powder as well as not exceeding 40 percent of the total mass of the nonmagnetic layer. These carbon blacks may be used singly or in combination. For example, the Carbon Black Handbook compiled by the Carbon Black Association may be consulted for types of carbon black suitable for use in the nonmagnetic layer of the present invention.

Based on the objective, an organic powder may be added to the nonmagnetic layer. Examples of such an organic powder are acrylic styrene resin powders, benzoguanamine resin powders, melamine resin powders, and phthalocyanine pigments. Polyolefin resin powders, polyester resin powders, polyamide resin powders, polyimide resin powders, and polyfluoroethylene resins may also be employed. The manufacturing methods described in Japanese Unexamined Patent Publication (KOKAI) Showa Nos. 62-18564 and 60-255827 may be employed. The contents of the above publications are expressly incorporated herein by reference in their entirety.

Binders, lubricants, dispersing agents, additives, solvents, dispersion methods, and the like suited to the magnetic layer may be adopted to the nonmagnetic layer. In particular, known techniques for the quantity and type of binder and the quantity and type of additives and dispersion agents employed in the magnetic layer may be adopted thereto.

An undercoating layer can be provided in the magnetic recording medium of the present invention. Providing an undercoating layer can enhance adhesive strength between the support and the magnetic layer or nonmagnetic layer. For example, a polyester resin that is soluble in solvent can be employed as the undercoating layer to enhance the adhesion.

The smoothing layer can be provided between the nonmagnetic support and the nonmagnetic layer to form a smooth nonmagnetic layer by masking the roughness of the surface of the nonmagnetic support in the present invention. For example, the smoothing layer can be formed by coating and drying a coating liquid comprising a polymer on the surface of the nonmagnetic support, or by coating a coating liquid comprising a compound (radiation-curable compound) comprising intramolecular radiation-curable functional groups and then irradiating it with radiation to cure the coating liquid.

A radiation-curable compound having a molecular weight ranging from 200 to 2,000 is desirably employed. When the molecular weight is within the above range, the relatively low molecular weight can facilitate coating flow during the calendering step, increasing moldability and permitting the formation of a smooth coating.

A radiation-curable compound in the form of a bifunctional acrylate compound with the molecular weight of 200 to 2,000 is desirable. Bisphenol A, bisphenol F, hydrogenated bisphenol A, hydrogenated bisphenol F, and compounds obtained by adding acrylic acid or methacrylic acid to alkylene oxide adducts of these compounds are preferred.

The radiation-curable compound can be used in combination with a polymeric binder. Examples of the binder employed in combination are conventionally known thermoplastic resins, thermosetting resins, reactive resins, and mixtures thereof. When the radiation employed in the curing process is UV radiation, a polymerization initiator is desirably employed in combination. A known photoradical polymerization initiator, photocationic polymerization initiator, photoamine generator, or the like can be employed as the polymerization initiator.

A radiation-curable compound can also be employed in the nonmagnetic layer to enhance the resistance to solvent of the nonmagnetic layer.

Layer Structure

As for the thickness structure of the magnetic recording medium of the present invention, the thickness of the nonmagnetic support preferably ranges from 3 to 80 micrometers, more preferably from 3 to 50 micrometers, further preferably from 3 to 10 micrometers, as set forth above. When an undercoating layer is provided between the nonmagnetic support and the nonmagnetic layer, the thickness of the undercoating layer ranges from, for example, 0.01 to 0.8 micrometer, preferably 0.02 to 0.6 micrometer.

The thickness of the magnetic layer is, as set forth above, 30 to 130 nm, preferably 30 to 120 nm, more preferably 30 to 100 nm, and further preferably, 30 to 80 nm. The thickness variation (σ/δ) in the magnetic layer is preferably within ±50 percent, more preferably within ±30 percent. At least one magnetic layer is sufficient. The magnetic layer may be divided into two or more layers having different magnetic characteristics, and a known configuration relating to multilayered magnetic layer may be applied.

The thickness of the nonmagnetic layer ranges from, for example, 0.1 to 3.0 μm, preferably 0.3 to 2.0 μm, and more preferably 0.5 to 1.5 μm. The nonmagnetic layer is effective so long as it is substantially nonmagnetic in the magnetic recording medium of the present invention. For example, it exhibits the effect of the present invention even when it comprises impurities or trace amounts of magnetic material that have been intentionally incorporated, and can be viewed as substantially having the same configuration as the magnetic recording medium of the present invention. The term “substantially nonmagnetic” is used to mean having a residual magnetic flux density in the nonmagnetic layer of equal to or less than 10 mT, or a coercivity of equal to or less than 7.96 kA/m (100 Oe), it being preferable not to have a residual magnetic flux density or coercivity at all.

Back Layer

A back layer is desirably provided on the opposite surface of the nonmagnetic support from the surface on which the nonmagnetic layer and the magnetic layer are provided, in the magnetic recording medium of the present invention. The back layer desirably comprises carbon black and inorganic powder. The formula of the magnetic layer or nonmagnetic layer can be applied to the binder and various additives for the formation of the back layer. The back layer is preferably equal to or less than 0.9 micrometer, more preferably 0.1 to 0.7 micrometer, in thickness.

Manufacturing Method

The process for manufacturing a coating liquid for forming a magnetic layer, a nonmagnetic layer or a back layer comprises at least a kneading step, a dispersing step, and a mixing step to be carried out, if necessary, before and/or after the kneading and dispersing steps. Each of the individual steps may be divided into two or more stages. All of the starting materials employed in the present invention, including the ferromagnetic powder, nonmagnetic powder, binders, carbon black, abrasives, antistatic agents, lubricants, solvents, and the like, may be added at the beginning of, or during, any of the steps. Moreover, the individual starting materials may be divided up and added during two or more steps. For example, polyurethane may be divided up and added in the kneading step, the dispersion step, and the mixing step for viscosity adjustment after dispersion. To achieve the object of the present invention, conventionally known manufacturing techniques may be utilized for some of the steps. A kneader having a strong kneading force, such as an open kneader, continuous kneader, pressure kneader, or extruder is preferably employed in the kneading step. Details of the kneading process are described in Japanese Unexamined Patent Publication (KOKAI) Heisei Nos. 1-106338 and 1-79274. The contents of these publications are incorporated herein by reference in their entirety. Further, glass beads may be employed to disperse the magnetic layer, nonmagnetic layer or back layer coating liquid, with a dispersing medium with a high specific gravity such as zirconia beads, titania beads, and steel beads being suitable for use as the glass beads. The particle diameter and fill ratio of these dispersing media can be optimized for use. A known dispersing device may be employed. Smoothing the nonmagnetic layer surface is effective in controlling variation in the interface between the nonmagnetic layer and the magnetic layer. Thus, it is possible to employ a method of improving the dispersion conditions of the nonmagnetic layer coating liquid relative to the dispersion conditions of the magnetic layer coating liquid. That is, small-diameter beads of high specific gravity can be used as the dispersion medium to effectively increase the fill rate. A long dispersion time is also desirably employed within a range that is suitable for production.

In the manufacturing method of the magnetic recording medium, for example, a nonmagnetic layer coating liquid is coated in a manner calculated to yield a prescribed film thickness to the surface of a nonmagnetic support while the support is being run to form a nonmagnetic layer, after which magnetic layer coating liquid is coated in a manner calculated to yield a prescribed film thickness thereover to form a magnetic layer. As set forth above, to smooth the nonmagnetic layer, it is possible to conduct a smoothing process on the surface of the nonmagnetic layer prior to coating the magnetic layer coating liquid. The nonmagnetic layer can be rendered smooth by calendering. A desired degree of smoothness can be set by adjusting the calendering pressure, calender roll temperature, calender roll material, and processing speed, described further below. Further, the nonmagnetic layer can be thermoprocessed following the calendering step to promote thermal curing. Promoting curing of the nonmagnetic layer prior to coating the magnetic layer can enhance the resistance to solvent of the nonmagnetic layer and suppress roughness in the interface between the nonmagnetic layer and the magnetic layer. Thermoprocessing conditions include, by way of example, a temperature of 35 to 100° C., desirably 50 to 80° C. The duration of thermoprocessing is, for example, 12 to 72 hours, desirably 24 to 48 hours.

Multiple magnetic layer coating liquids can be successively or simultaneously coated in a multilayer coating, or the nonmagnetic layer coating liquid and magnetic layer coating liquid can be successively or simultaneously coated in a multilayer coating. Coating machines suitable for use in coating the magnetic layer or nonmagnetic layer coating liquid are air doctor coaters, blade coaters, rod coaters, extrusion coaters, air knife coaters, squeeze coaters, immersion coaters, reverse roll coaters, transfer roll coaters, gravure coaters, kiss coaters, cast coaters, spray coaters, spin coaters, and the like. For example, “Recent Coating Techniques” (May 31, 1983), issued by the Sogo Gijutsu Center K.K. may be referred to in this regard.

When it is a magnetic tape, the coating layer that is formed by applying the magnetic layer coating liquid can be magnetic field orientation processed using cobalt magnets or solenoids on the ferromagnetic powder contained in the coating layer. When it is a disk, an adequately isotropic orientation can be achieved in some products without orientation using an orientation device, but the use of a known random orientation device in which cobalt magnets are alternately arranged diagonally, or alternating fields are applied by solenoids, is desirable. In the case of ferromagnetic metal powder, the term “isotropic orientation” generally refers to a two-dimensional in-plane random orientation, which is desirable, but can refer to a three-dimensional random orientation achieved by imparting a perpendicular component. Further, a known method, such as opposing magnets of opposite poles, can be employed to effect perpendicular orientation, thereby imparting an isotropic magnetic characteristic in the peripheral direction. Perpendicular orientation is particularly desirable when conducting high-density recording. Spin coating can be used to effect peripheral orientation.

The drying position of the coating is desirably controlled by controlling the temperature and flow rate of drying air, and coating speed. A coating speed of 20 m/min to 1,000 m/min and a dry air temperature of equal to or higher than 60° C. are desirable. Suitable predrying can be conducted prior to entry into the magnet zone.

The coated stock material thus obtained can be normally temporarily wound on a take-up roll, and then unwound from the take-up roll and calendered.

For example, super calender rolls can be employed in calendering. Calendering can enhance surface smoothness, eliminate voids produced by the removal of solvent during drying, and increase the fill rate of the ferromagnetic powder in the magnetic layer, thus yielding a magnetic recording medium of good electromagnetic characteristics. The calendering step is desirably conducted by varying the calendering conditions based on the smoothness of the surface of the coated stock material.

The glossiness of the coated stock material may decrease roughly from the center of the take-up roll toward the outside, and there is sometimes variation in the quality in the longitudinal direction. Glossiness is known to correlate to the surface roughness Ra. Accordingly, when the calendering conditions are not varied in the calendering step, such as by maintaining a constant calender roll pressure, there is no countermeasure for the difference in smoothness in the longitudinal direction resulting from winding of the coated stock material, and the variation in quality in the longitudinal direction tends to carry over into the final product.

Accordingly, in the calendering step, it is desirable to vary the calendering conditions, such as the calender roll pressure, to cancel out the different in smoothness in the longitudinal direction that is produced by winding of the coated stock material. Specifically, it is desirable to reduce the calender roll pressure from the center to the outside of the coated stock material that is wound off the take-up roll. Based on an investigation by the present inventors, lowering the calender roll pressure decreases the glossiness (smoothness diminishes). Thus, the difference in smoothness in the longitudinal direction that is produced by winding of the coated stock material is cancelled out, yielding a final product free of variation in quality in the longitudinal direction.

An example of changing the pressure of the calender rolls has been described above. Additionally, it is possible to control the calender roll temperature, calender roll speed, and calender roll tension. Taking into account the properties of a particulate medium, it is desirable to control the surface smoothness by means of the calender roll pressure and calender roll temperature. The calender roll pressure is reduced, or the calender roll temperature is lowered, to diminish the surface smoothness of the final product. Conversely, the calender roll pressure is increased or the calender roll temperature is raised to increase the surface smoothness of the final product.

Alternatively, the magnetic recording medium obtained following the calendering step can be thermally processed to promote thermal curing. Such thermal processing can be suitably determined based on the blending formula of the magnetic layer coating liquid, for example, at 35 to 100° C., desirably at 50 to 80° C. The thermal processing time is 12 to 72 hours, desirably 24 to 48 hours.

Rolls of a heat-resistant plastic such as epoxy, polyimide, polyamide, or polyamidoimide, can be employed as the calender rolls. Processing with metal rolls is also possible.

The calendering conditions are as follows. The calender roll temperature is, for example, set to within a range of 60 to 100° C., desirably within a range of 70 to 100° C., and preferably within a range of 80 to 100° C. The pressure, for example, ranges from 100 to 500 kg/cm (98 to 490 kN/m), desirably ranges from 200 to 450 kg/cm (196 to 441 kN/m), and preferably, ranges from 300 to 400 kg/cm (294 to 392 kN/m). The surface of the nonmagnetic layer is also preferably calendered under these conditions.

The magnetic layer in the magnetic recording medium of the present invention desirably has a center surface average surface roughness Ra of 0.5 to 2.5 nm, preferably 0.8 to 2.0 nm, and more preferably, 1.0 to 1.5 nm, as measured by an atomic force microscope (AFM).

The ten-point average roughness Rz of the magnetic layer is desirably equal to or less than 30 nm. These values can be controlled by controlling the surface properties with the filler in the support, the roll surface shape during calendaring, and the like. The curl is desirably within ±3 mm.

The magnetic recording medium obtained can be cut to desired size with a cutter or the like for use. The cutter is not specifically limited, but desirably comprises multiple sets of a rotating upper blade (male blade) and lower blade (female blade). The slitting speed, engaging depth, peripheral speed ratio of the upper blade (male blade) and lower blade (female blade) (upper blade peripheral speed/lower blade peripheral speed), period of continuous use of slitting blade, and the like can be suitably selected.

[Physical Properties]

The coercivity (Hc) of the magnetic layer is preferably 143.2 to 318.3 kA/m (1,800 to 4,000 Oe), more preferably 159.2 to 278.5 kA/m (2,000 to 3,500 Oe). Narrower coercivity distribution is preferable. The SFD and SFDr are preferably equal to or lower than 0.6, more preferably equal to or lower than 0.3.

The coefficient of friction of the magnetic recording medium of the present invention relative to the head is, for example, equal to or less than 0.50 and preferably equal to or less than 0.3 at temperatures ranging from −10° C. to 40° C. and humidity ranging from 0 percent to 95 percent, the surface resistivity on the magnetic surface preferably ranges from 10⁴ to 10⁸ ohm/sq, and the charge potential preferably ranges from −500 V to +500 V. The modulus of elasticity at 0.5 percent extension of the magnetic layer preferably ranges from 0.98 to 19.6 GPa (100 to 2,000 kg/mm²) in each in-plane direction. The breaking strength preferably ranges from 98 to 686 MPa (10 to 70 kg/mm²). The modulus of elasticity of the magnetic recording medium preferably ranges from 0.98 to 14.7 GPa (100 to 1500 kg/mm²) in each in-plane direction. The residual elongation is preferably equal to or less than 0.5 percent, and the thermal shrinkage rate at all temperatures below 100° C. is preferably equal to or less than 1 percent, more preferably equal to or less than 0.5 percent, and most preferably equal to or less than 0.1 percent.

The glass transition temperature (i.e., the temperature at which the loss elastic modulus of dynamic viscoelasticity peaks as measured at 110 Hz with a dynamic viscoelastometer, such as RHEOVIBRON) of the magnetic layer preferably ranges from 50 to 180° C., and that of the nonmagnetic layer preferably ranges from 0 to 180° C. The loss elastic modulus preferably falls within a range of 1×10⁷ to 8×10⁸ Pa (1×10⁸ to 8×10⁹ dyne/cm²) and the loss tangent is preferably equal to or less than 0.2. Adhesion failure tends to occur when the loss tangent becomes excessively large. These thermal characteristics and mechanical characteristics are desirably nearly identical, varying by equal to or less than 10 percent, in each in-plane direction of the medium.

The residual solvent contained in the magnetic layer is preferably equal to or less than 100 mg/m² and more preferably equal to or less than 10 mg/m². The void ratio in the coated layers, including both the nonmagnetic layer and the magnetic layer, is preferably equal to or less than 40 volume percent, more preferably equal to or less than 30 volume percent. Although a low void ratio is preferable for attaining high output, there are some cases in which it is better to ensure a certain level based on the object. For example, in many cases, larger void ratio permits preferred running durability in disk media in which repeat use is important.

Physical properties of the nonmagnetic layer and magnetic layer may be varied based on the objective in the magnetic recording medium of the present invention. For example, the modulus of elasticity of the magnetic layer may be increased to improve running durability while simultaneously employing a lower modulus of elasticity than that of the magnetic layer in the nonmagnetic layer to improve the head contact of the magnetic recording medium.

The magnetic recording medium of the present invention affords excellent recording and reproduction characteristics in the short wavelength region, as set forth above. The magnetic recording medium of the present invention is suited to magnetic recording and reproduction systems in which a signal recorded at high density is reproduced with an AMR head or a GMR head, desirably a GMR head.

Normally, two units are employed to denote linear recording density: fci and bpi. “fci” denotes the density that is physically recorded on the medium as the number of bit reversals per inch, while “bpi” denotes the number of bits per inch, including signal processing, and is system-dependent. Thus, the fci is normally employed for pure performance evaluation of a medium. The desirable linear recording density range in the course of recording a signal on the magnetic recording medium of the present invention is 100 to 400 kfci, with 175 to 400 kfci being preferred. In systems actually in use, this depends on signal processing, and cannot be determined once and for all. As a general guideline, performance is reflected by an fci of 0.5 to one times the bpi. Thus, a range of 200 to 800 kbpi is desirable, 350 to 800 kbpi being preferred.

The distance between shields (sh-sh) on the reproduction head is, for example, 0.1 to 0.3 micrometer and the reproduction track width is, for example, 0.5 to 10.0 micrometers. GMR heads exploit a magnetoresistive effect corresponding to the magnitude of the magnetic flux on a thin-film magnetic head, affording advantages unachievable with inductive heads, such as attaining high reproduction output levels. This is primarily because there is no dependence on the relative speed between the medium and the head, since the reproduction output of a GMR head is based on change in magnetoresistance. In particular, GMR heads permit an about threefold improvement in reading sensitivity over AMR heads. The use of such a GMR head as the reproduction head permits the reproduction with high sensitivity of signals that have been recorded at high density in the short wavelength region.

A highly sensitive AMR head can also be employed as the above reproduction head. Generally, the coefficient of magnetoresistance is employed as the indicator of sensitivity of a head. Commonly employed magnetoresistive elements have a coefficient of magnetoresistance of about 2 percent at a thickness of 200 to 300 nm. By contrast, this is about 2 to 5 percent for highly sensitive AMR heads. When employing a highly sensitive AMR head, it is also possible to reproduce with high sensitivity signals that have been recorded on the magnetic recording medium of the present invention to achieve a high S/N ratio.

Use of a GMR head as the reproduction head when the magnetic recording medium of the present invention is a tape magnetic recording medium permits reproduction at a high S/N ratio even when the signal has been recorded in a shorter wavelength range that is conventionally the case. Accordingly, the magnetic recording medium of the present invention is optimal as a magnetic recording medium in either magnetic tape or disk form for use in high-density recording of computer data.

[Magnetic Signal Reproduction System, Magnetic Signal Reproduction Method]

The present invention further relates to a magnetic signal reproduction system comprising the magnetic recording medium of the present invention and a reproduction head, and to a magnetic signal reproduction method reproducing magnetic signals that have been recorded on the magnetic recording medium of the present invention with a reproduction head. The above reproduction head is desirably an MR head, preferably a GMR head. Details of the magnetic recording medium, reproduction head and the like employed in the magnetic signal reproduction system and the magnetic signal reproduction method of the present invention are as set fort above.

As set forth above, the magnetic recording medium of the present invention can achieve excellent recording and reproduction characteristics in the short wavelength region, permitting highly sensitive reading with GMR heads. The magnetic signal reproduction method and magnetic signal reproduction system of the present invention employing such a magnetic recording medium permit the reproduction of signals recorded at high density with a good S/N ratio.

### EXAMPLES

The present invention will be described in greater detail below through Examples. The components, ratios, operations, sequences, and the like indicated here can be modified without departing from the spirit of the present invention, and are not to be construed as being limited to Examples set forth below. The “parts” given in Examples denote mass parts unless specifically indicated otherwise.

### Examples 1 to 15, Comparative Examples 1 to 5, 7 to 10

### Preparation of Magnetic Layer Coating Liquid 1 (Ferromagnetic Powder: Hexagonal Ferrite Powder (Described as “BaFe” in Table 1)

| | | |
|---|---|---|
| Ferromagnetic plate-shaped hexagonal ferrite powder | 100 | parts |
| Composition other than oxygen (molar ratio): | | |
| Ba/Fe/Co/Zn = 1/9/0.2/1 | | |
| Hc: 160 kA/m (2000 Oe) | | |
| Average plate diameter and average plate ratio: | | |
| see exhibit | | |
| BET specific surface area: 65 m²/g | | |
| σs: 49 A · m²/kg (49 emu/g) | | |
| Polyurethane resin based on branched side chain- | 15 | parts |
| comprising polyester polyol/diphenylmethane | | |
| diisocyanate, —SO₃Na = 400 eq/ton | | |
| α-Al₂O₃ (particle size: 0.15 micrometer) | 4 | parts |
| Plate-shaped alumina powder | 0.5 | part |
| Diamond powder (average particle diameter: 60 nm) | 0.5 | part |
| Carbon black (average particle diameter: 20 nm) | 1 | part |
| Cyclohexanone | 110 | parts |
| Methyl ethyl ketone | 100 | parts |
| Toluene | 100 | parts |
| Butyl stearate | 2 | parts |
| Stearic acid | 1 | part |

Preparation of Magnetic Layer Coating Liquid 2 (Ferromagnetic Powder: Ferromagnetic Metal Powder (Described as “MP” in Table 1))

| | | |
|---|---|---|
| Ferromagnetic acicular metal powder | 100 | parts |
| Composition: Fe/Co/Al/Y = 62/25/5/8 | | |
| Surface treatment layer: Al₂O₃, Y₂O₃ | | |
| Hc: 167 kA/m (2100 Oe) | | |
| Crystallite size: 9 nm | | |
| Average major axis length: 40 nm | | |
| Average acicular ratio: 6 | | |
| BET specific surface area: 80 m²/g | | |
| σs: 110 A · m²/kg (110 emu/g) | | |
| Polyurethane resin based on branched side chain- | 17 | parts |
| comprising polyester polyol/diphenylmethane | | |
| diisocyanate, —SO₃Na = 100 eq/ton | | |
| Phenylphosphonic acid | 3 | parts |
| α-Al₂O₃ (particle size: 0.15 micrometer) | 5 | parts |
| Diamond powder (average particle diameter: 60 nm) | 1 | part |
| Cyclohexanone | 110 | parts |
| Methyl ethyl ketone | 100 | parts |
| Toluene | 100 | parts |
| Butyl stearate | 2 | parts |
| Stearic acid | 1 | part |

Preparation of Magnetic Layer Coating Liquid 3 (Ferromagnetic Powder: Iron Nitride Powder)

| | | |
|---|---|---|
| Iron nitride magnetic powder (average particle | 100 | parts |
| diameter: 20 nm) | | |
| Hc: 15.9 kA/m (2000 Oe) | | |
| BET specific surface area: 63 m²/g | | |
| σs: 100 A · m²/kg (100 emu/g) | | |
| Vinyl chloride-hydroxypropyl acrylate copolymer resin | 8 | parts |
| (—SO₃Na group content: 0.7 × 10⁻⁴ eq/g) | | |
| Polyurethane resin based on branched side chain- | 25 | parts |
| comprising polyester polyol/diphenylmethane | | |
| diisocyanate, —SO₃Na = 400 eq/ton | | |
| α-alumina (average particle diameter: 80 nm) | 5 | parts |
| Plate-shaped alumina powder (average particle diameter: | 1 | part |
| 50 nm) | | |
| Diamond powder (average particle diameter: 80 nm) | 1 | part |
| Carbon black (average particle diameter: 25 nm) | 1.5 | parts |
| Myristic acid | 1.5 | parts |
| Methyl ethyl ketone | 133 | parts |
| Toluene | 100 | parts |
| Stearic acid | 1.5 | parts |
| Polyisocyanate (Coronate L made by Nippon Polyurethane | 4 | parts |
| Industry Co. Ltd.) | | |
| Cyclohexanone | 133 | parts |
| Toluene | 33 | parts |

Preparation of Nonmagnetic Layer Coating Liquid

| | | |
|---|---|---|
| Nonmagnetic inorganic powder | 85 | parts |
| α-iron oxide | | |
| Surface treatment layer: Al₂O₃, SiO₂ | | |
| Average major axis length: 0.15 micrometer | | |
| Tap density: 0.8 | | |
| Average acicular ratio: 7 | | |
| BET specific surface area: 52 m²/g | | |
| pH: 8 | | |
| DBP oil absorption capacity: 33 g/100 g | | |
| Carbon black | 15 | parts |
| DBP oil absorption capacity: 120 mL/100 g | | |
| pH: 8 | | |
| BET specific surface area: 250 m²/g | | |
| Volatile content: 1.5 percent | | |
| Vinyl chloride resin (MR 110 made by Nippon Zeon | 10 | parts |
| Co., Ltd.) | | |
| Polyurethane resin based on branched side chain- | 10 | parts |
| comprising polyester polyol/diphenylmethane | | |
| diisocyanate, —SO₃Na = 120 eq/ton | | |
| Phenylphosphonic acid | 3 | parts |
| Cyclohexanone | 140 | parts |
| Methyl ethyl ketone | 170 | parts |
| Butyl stearate | 2 | part |
| Stearic acid | 1 | part |

Preparation of Back Layer Coating Liquid

| | | |
|---|---|---|
| Carbon black (average particle diameter: 25 nm) | 40.5 | parts |
| Carbon black (average particle diameter: 370 nm) | 0.5 | part |
| Barium sulfate | 4.05 | parts |
| Nitrocellulose | 28 | parts |
| SO₃Na group-containing polyurethane resin | 20 | parts |
| Cyclohexanone | 100 | parts |
| Toluene | 100 | parts |
| Methyl ethyl ketone | 100 | parts |

The various components of the above-described magnetic layer coating liquid, nonmagnetic layer coating liquid, and back layer coating liquid were kneaded for 240 minutes in an open kneader and dispersed in a sand mill using 0.5 mm zirconia beads. The magnetic layer coating liquid and the nonmagnetic layer coating liquid were dispersed for the periods shown in Table 1, and the back layer coating liquid was dispersed for six hours. To each of the dispersions obtained were added four parts of trifunctional low-molecular-weight polyisocyanate compound (Coronate 3041 made by Nippon Polyurethane Industry Co.), and the mixtures were stirred for another 20 minutes. Subsequently, the mixtures were filtered using a filter having an average pore diameter of 0.5 micrometer to prepare coating liquids for forming the various layers.

The nonmagnetic layer coating liquid obtained was coated to a polyethylene naphthalate support 5 micrometer in thickness with a centerline average roughness of 0.002 micrometer in a quantity calculated to yield a dry thickness of 1.5 micrometers. A smoothing process was conducted. (A hard, platelike flat smoother (Ra≦2.5 nm) was brought into contact with the wet surface to apply a shear. The “Smoothing process” in Table 1 indicates whether or not this process was conducted). Subsequently, the coating was dried at 100° C., yielding a nonmagnetic layer stock material. The nonmagnetic layer stock material was then subjected to a 24-hour heat treatment at 70° C. (the “Lower layer heat treatment” in Table 1 indicates whether or not this process was conducted) and calendering under conditions of a speed of 100 m/min, a linear pressure of 350 kg/cm (343 kN/m), and a temperature of 100° C. with a seven-stage calender comprised of metal rolls (the “Lower layer 2R process” in Table 1 indicates whether or not this process was conducted).

Subsequently, magnetic layer coating liquid 1, 2, or 3 was coated wet-on-dry on the nonmagnetic layer in a quantity calculated to yield the dry thickness indicated in Table 1. A smoothing process (the “Smoothing process” in Table 1 indicates whether or not this process was conducted) was conducted, after which the coating was dried at 100° C. Subsequently, surface smoothing was conducted at the temperature indicated in Table 1 (recorded in the “Lower layer 2R process” in Table 1) at a linear pressure of 350 kg/cm (343 kN/m) at a speed of 100 m/min with a seven-stage calender comprised only of metal rolls. The material was then slit into a ½ inch width to obtain magnetic tape.

### Comparative Example 6

The nonmagnetic layer coating liquid, in a quantity calculated to yield a dry thickness of 2 micrometers, and magnetic layer coating liquid 1, in a quantity calculated to yield a dry thickness of 100 nm, were simultaneously multilayer coated at a coating speed of 200 m/min on a polyethylene naphthalate support 5 micrometer in thickness with a centerline average roughness of 0.002 micrometer, and subjected to longitudinal orientation by blowing 80° C. dry air through a 5 m zone of cobalt magnets with homopolar magnets of opposite poles having a magnetic force of 5,000 G (0.5 T). Subsequently, calendering was conducted at a temperature of 100° C. with a seven-stage calender comprised only of metal rolls. The material was then slit into a ½ inch width to obtain magnetic tape.

[Measurement Methods]

The tape samples obtained were measured and evaluated by the following methods. The results are given in Table 1.

(1) Measurement of the Center Surface Average Surface Roughness Ra of the Magnetic Layer

The center surface average surface roughness Ra of the magnetic layer was obtained under the following conditions by an atomic force microscope (AFM).

Device: Nanoscope III made by Veeco Japan.
Mode: AFM mode (contact mode)
Measurement scope: 40 micrometer square
Scan lines: 512*512
Scan speed: 2 Hz
Scan direction: Parallel to the width direction of the tape.

(2) Measurement of Electromagnetic Characteristics

Electromagnetic characteristics were measured by the following method with a drum tester (relative speed 2 m/s).

A signal was recorded at a linear recording density of 200 kfci with a write head with a Bs=1.7 T and a gap length of 0.2 micrometer and reproduced with a GMR head (reproduction track width (Tw): 2.0 micrometer, sh-sh=0.16 micrometer). The S/N ratio was obtained by measuring the ratio of the output at 200 kfci (recording wavelength: 254 nm) to the integral noise at 0 to 400 kfci.

(3) Glossiness

Glossiness was measured in the longitudinal direction (running direction of the tape) according to JIS Z8741 with a gloss meter employing the mirror-surface glossiness of a glass surface with a refractive index of 1.567 at an angle of incidence of 45° C. as 100 percent.

TABLE 1

| | | Magnetic material | | | | Lower layer | | | |
|---|---|---|---|---|---|---|---|---|---|
| | | Type of magnetic | Plate | | φm | Dispersion time | | Lower layer | Lower layer |
| | | material in | diameter | Plate | (mT · | for lower layer | Smoothing process | heat treatment | 2R process |
| | | the upper layer | nm | ratio | μm) | time (hours) | Conducted or not | Conducted or not | Conducted or not |
| Example | 1 | BaFe | 25 | 3 | 5 | 36 | Conducted | Conducted | Conducted |
| | 2 | BaFe | 25 | 3 | 12 | 36 | Conducted | Conducted | Conducted |
| | 3 | BaFe | 25 | 3 | 20 | 36 | Conducted | Conducted | Conducted |
| | 4 | BaFe | 25 | 3 | 12 | 24 | Conducted | Conducted | Conducted |
| | 5 | BaFe | 25 | 3 | 12 | 72 | Conducted | Conducted | Conducted |
| | 6 | BaFe | 25 | 3 | 12 | 24 | Conducted | Conducted | Conducted |
| | 7 | BaFe | 25 | 3 | 12 | 24 | Conducted | Conducted | Conducted |
| | 8 | BaFe | 25 | 3 | 20 | 36 | Conducted | Conducted | Conducted |
| | 9 | MP | — | — | 20 | 36 | Conducted | Conducted | Conducted |
| | 10 | Iron nitride | — | — | 20 | 36 | Conducted | Conducted | Conducted |
| | 11 | BaFe | 10 | 3 | 10 | 36 | Conducted | Conducted | Conducted |
| | 12 | BaFe | 15 | 3 | 10 | 36 | Conducted | Conducted | Conducted |
| | 13 | BaFe | 40 | 3 | 10 | 36 | Conducted | Conducted | Conducted |
| | 14 | BaFe | 25 | 1.5 | 10 | 36 | Conducted | Conducted | Conducted |
| | 15 | BaFe | 25 | 4.5 | 10 | 36 | Conducted | Conducted | Conducted |
| Comp. Ex. | 1 | BaFe | 25 | 3 | 12 | 8 | None | None | None |
| | 2 | BaFe | 25 | 3 | 12 | 8 | None | None | None |
| | 3 | BaFe | 25 | 3 | 12 | 96 | Conducted | Conducted | Conducted |
| | 4 | BaFe | 25 | 3 | 4 | 72 | Conducted | Conducted | Conducted |
| | 5 | BaFe | 25 | 3 | 23 | 72 | None | None | None |
| | 6 | BaFe | 25 | 3 | 15 | 36 | Simultaneously | Simultaneously | Simultaneously |
| | | | | | | | moltilayer coating | moltilayer coating | moltilayer coating |
| | 7 | BaFe | 5 | 3 | 10 | 36 | Conducted | Conducted | Conducted |
| | 8 | BaFe | 45 | 3 | 10 | 36 | Conducted | Conducted | Conducted |
| | 9 | BaFe | 25 | 1 | 10 | 36 | Conducted | Conducted | Conducted |
| | 10 | BaFe | 25 | 5 | 10 | 36 | Conducted | Conducted | Conducted |

| | | Upper layer | | | | 5 × | | | Magnetic | |
|---|---|---|---|---|---|---|---|---|---|---|
| | | Dispersion time | | 2R | | φm + | Glossi- | | layer | |
| | | for upper layer | Smoothing process | process | | 130 | ness | Ra | thickness | SNR |
| | | time (hours) | Conducted or not | Temp. | | (%) | (%) | (nm) | (nm) | (dB) |
| Example | 1 | 36 | Conducted | 100° | C. | 155 | 155 | 1 | 30 | 6 |
| | 2 | 36 | Conducted | 100° | C. | 190 | 240 | 1 | 80 | 7 |
| | 3 | 36 | Conducted | 100° | C. | 230 | 270 | 1 | 130 | 6 |
| | 4 | 24 | None | 100° | C. | 190 | 210 | 1.5 | 80 | 5 |
| | 5 | 72 | Conducted | 100° | C. | 190 | 260 | 0.7 | 80 | 9 |
| | 6 | 24 | None | 90° | C. | 190 | 190 | 2.5 | 80 | 4 |
| | 7 | 24 | None | 80° | C. | 190 | 170 | 2.7 | 80 | 2 |
| | 8 | 36 | None | 80° | C. | 230 | 170 | 2.5 | 130 | 3 |
| | 9 | 36 | Conducted | 100° | C. | 230 | 250 | 1.5 | 70 | 3 |
| | 10 | 36 | Conducted | 100° | C. | 230 | 230 | 1.3 | 90 | 2.5 |
| | 11 | 36 | Conducted | 100° | C. | 180 | 180 | 1.5 | 70 | 6 |
| | 12 | 36 | Conducted | 100° | C. | 180 | 220 | 1 | 70 | 6 |
| | 13 | 36 | Conducted | 100° | C. | 180 | 240 | 1 | 70 | 7 |
| | 14 | 36 | Conducted | 100° | C. | 180 | 190 | 1 | 70 | 5 |
| | 15 | 36 | Conducted | 100° | C. | 180 | 210 | 1 | 70 | 6 |
| Comp. Ex. | 1 | 8 | None | 100° | C. | 190 | 140 | 2 | 80 | −0.5 |
| | 2 | 8 | None | 120° | C. | 190 | 150 | 1.7 | 80 | 1 |
| | 3 | 96 | Conducted | 100° | C. | 190 | 280 | 0.6 | 80 | Measurement was |
| | | | | | | | | | | not possible |
| | | | | | | | | | | due to cracking. |
| | 4 | 72 | None | 100° | C. | 150 | 165 | 1.5 | 25 | 0.5 |
| | 5 | 8 | None | 100° | C. | 245 | 215 | 2 | 150 | 1 |
| | 6 | 36 | Simultaneously | 100° | C. | 205 | 130 | 2 | 100 | −1 |
| | | | moltilayer | | | | | | | |
| | | | coating | | | | | | | |
| | 7 | 36 | Conducted | 100° | C. | 180 | 140 | 2 | 70 | 0.5 |
| | 8 | 36 | Conducted | 100° | C. | 180 | 150 | 2 | 70 | 1.5 |
| | 9 | 36 | Conducted | 100° | C. | 180 | 140 | 2 | 70 | 1 |
| | 10 | 36 | Conducted | 100° | C. | 180 | 145 | 2 | 70 | 1 |

It will be understood from Table 1 that Examples 1 to 15 achieved far better S/N ratios than the comparative examples.

By contrast, the S/N ratio dropped in all of Comparative Examples 1, 2, and 7 to 10, in which the glossiness of the surface of the magnetic layer was less than 155 percent, and Comparative Examples 4 and 5, in which the thickness of the magnetic layer was outside the range of 30 to 130 nm. Comparative Example 3, in which the glossiness of the surface of the magnetic layer exceeded 270 percent, exhibited a coating with poor durability that cracked during measurement, precluding measurement. Due to roughness of the interface between the magnetic layer and nonmagnetic layer caused by simultaneous multilayer coating, Comparative Example 6 exhibited a drop in glossiness of the magnetic layer surface. As a result, an adequate S/N ratio could not be achieved.

The magnetic recording medium of the present invention is suitable for use as a magnetic recording medium for high-density recording.

1. A magnetic recording medium comprising a nonmagnetic layer comprising a nonmagnetic powder and a binder and a magnetic layer comprising a ferromagnetic powder and a binder in this order on a nonmagnetic support, wherein
the magnetic layer has a thickness ranging from 30 to 130 nm, and
a glossiness of the magnetic layer surface ranges from 155 to 270 percent.

2. The magnetic recording medium according to claim 1, wherein a saturation magnetic flux φm per unit area of the magnetic layer is equal to or greater than 5 mT·μm and equal to or less than 20 mT·μm.

3. The magnetic recording medium according to claim 2, wherein the glossiness of the magnetic layer surface is equal to or greater than (5×φm+130) percent and equal to or less than 270 percent.

4. The magnetic recording medium according to claim 1, wherein the ferromagnetic powder is a hexagonal ferrite powder.

5. The magnetic recording medium according to claim 4, wherein the hexagonal ferrite powder has an average plate diameter ranging from 10 to 40 nm and an average plate ratio ranging from 1.5 to 4.5.

6. The magnetic recording medium according to claim 1, which is employed in a magnetic signal reproduction system employing a giant magnetoresistive magnetic head as a reproduction head.

7. A magnetic signal reproduction system, comprising:
the magnetic recording medium according to claim 1, and a reproduction head.

8. The magnetic signal reproduction system according to claim 7, wherein the reproduction head is a giant magnetoresistive magnetic head.

9. A magnetic signal reproduction method, reproducing magnetic signals that have been recorded on the magnetic recording medium according to claim 1 with a reproduction head.

10. The magnetic signal reproduction method according to claim 9, wherein the reproduction head is a giant magnetoresistive magnetic head.
